(19) United States
(12) Patent Application Publication
(10) Pub. No.: US 2025/0130364 A1
(43) Pub. Date: Apr. 24, 2025

(54) OPTICAL FIBER EXHIBITING HIGH LP11 ATTENUATION BUT LOW LP01 ATTENUATION WHEN LOOPED

(71) Applicant: CORNING INCORPORATED, CORNING, NY (US)

(72) Inventors: Xin Chen, Painted Post, NY (US); Ming-Jun Li, Horseheads, NY (US); Yin Shu, Schenectady, NY (US)

(21) Appl. No.: 18/920,058

(22) Filed: Oct. 18, 2024

Related U.S. Application Data
(60) Provisional application No. 63/545,229, filed on Oct. 23, 2023.

(51) Int. Cl. G02B 6/028; G02B 6/036

(52) U.S. Cl. CPC G02B 6/0281; G02B 6/03683

(57) ABSTRACT

An optical fiber including: (1) a first outer cladding region including a no-slope portion establishing a 0% baseline (Δ₀); (2) a core region surrounded by the first outer cladding region, the core region including (i) an outer radius (r₁) from 4.0 μm to 6.5 μm and (ii) a maximum relative refractive index (Δ₁ₘₐₓ) from 0.3% to 0.6%, the core region exhibiting an α value of 5 or greater; and (3) a depressed index cladding region surrounding the core region and surrounded by the first outer cladding region, the depressed index cladding region including (i) an outer radius (r₃) from 14 μm to 28 μm, (ii) a relative refractive index (Δ₃) from −0.45% to −0.30%, and (iii) a trench volume (V_{T}) from 65%-μm² to 140%-μm². The optical fiber exhibits lower LP01 bending loss than LP11 bending loss at operating wavelengths in the O- and C-bands.

This application claims the benefit of priority under 35 U.S.C § 120 of U.S. Provisional Application Ser. No. 63/545,229 filed on Oct. 23, 2023, the content of which is relied upon and incorporated herein by reference in its entirety.

### TECHNICAL FIELD

The present disclosure pertains to optical fibers and, more particularly, to optical fibers that are looped during use.

### BACKGROUND

Electronics have heretofore typically relied upon the conduction of electrons through electron conductors such as copper traces. As demand for data communication grows, electron-based electronics are revealing limitations in terms of energy efficiency and processing speed. Silicon photonics has been proposed to overcome those limitations. With silicon photonics, instead of electron conductors conducting electrons, waveguides transmit light—or more precisely electromagnetic radiation, generally of a particular wavelength.

For example, data centers are beginning to use silicon photonics. Data centers house servers and networking equipment to process, store, and transfer large amounts of data. Photonic transceivers are finding applications to convert electrical signals from server components into optical signals for high-speed communication. Photonic transceivers employ a laser to create the signals as bursts of electromagnetic radiation primarily in the fundamental mode (LP01).

The acceptance of silicon photonics gives rise to forming adequate coupling between the photonic device and optical fiber. For example, going back to the photonic transceiver example, an optical fiber can be coupled to the photonic transceiver to further transmit the optical signals that the photonic transceiver created to another server or some other component, or even externally of the data center.

There are a variety of ways to couple a photonic device to an optical fiber. As one example, evanescent coupling involves proximity but not direct contact between the output waveguide of the photonic device and the end of the optical fiber. The coupling relies on capture and transmission of the decaying electromagnetic field extending beyond the output waveguide of the photonic device. A grating structure (with layers of alternating high- and low-refractive index material) between the output waveguide of the photonic device and the end of the optical fiber can be utilized to diffract and redirect the electromagnetic field into the optical fiber.

More direct coupling methods are also utilized, including “in-plane” coupling and facet coupling. With facet coupling, the end face of the optical fiber is faceted at an angle. The faceted end is then placed into contact with the output waveguide of the photonic device. The facet refracts emissions from the photonic device into the optical fiber. The optical fiber is often looped one or two times near the end of the optical fiber to control the bend radius of the optical fiber and alignment with the output waveguide.

However, there is a problem in that loops of small loop diameter in the optical fiber can attenuate the fundamental mode (LP01) that the photonic transceiver generates and decrease mechanical reliability. Further, there is a general desire to propagate the electromagnetic radiation that the photonic transceiver generates in only the fundamental mode (LP01) while suppressing higher order modes (e.g., LP11), to prevent dispersion and signal degradation.

### SUMMARY

The present disclosure addresses that problem and general desire with an optical fiber that includes (1) a positive index core region having (i) outer radius (r₁) within a range of from 4.0 μm to 6.5 μm, (ii) an α value of 5 or greater, and (iii) a maximum relative refractive index (Δ₁ₘₐₓ) from 0.3% to 0.6%, (2) a depressed index cladding region surrounding the core region having (i) an outer radius (r₃) from 14 μm to 28 μm, (ii) a relative refractive index (Δ₃) from −0.45% to −0.30%, and (iii) a trench volume (V_{T}) from 65%-μm² to 140%-μm², and (3) a first outer cladding region including a no-slope portion establishing a 0% baseline (Δ₀). When the optical fiber includes one or more loops, the optical fiber attenuates the first higher order mode (LP11) to a much greater degree than the fundamental mode (LP01) at operating wavelengths in the O- and C-bands.

According to a first aspect of the present disclosure, an optical fiber comprises: (1) a first outer cladding region comprising a no-slope portion where the first outer cladding has a refractive index that is substantially constant as a function of a radius from an axis of the optical fiber, wherein the no-slope portion establishes a 0% baseline (Δ₀) for relative refractive indices; (2) a core region surrounded by the first outer cladding region, the core region comprising (i) an outer radius (r₁) within a range of from 4.0 μm to 6.5 μm from the axis of the optical fiber and (ii) a maximum relative refractive index (Δ₁ₘₐₓ) within a range of from 0.3% to 0.6%, the core region exhibiting an α value that is greater than or equal to 5; and (3) a depressed index cladding region surrounding the core region and surrounded by the first outer cladding region, the depressed index cladding region comprising (i) an outer radius (r₃) from the axis of the optical fiber within a range of from 14 μm to 28 μm, (ii) a relative refractive index (Δ₃) within a range of from −0.45% to −0.30%, and (iii) a trench volume (V_{T}) that is within a range of from 65%-μm² to 140%-μm²; wherein (a) the optical fiber exhibits a LP01 bending loss for electromagnetic radiation having a wavelength within range of from 1260 nm to 1360 nm, (i) when looped 1 turn around a 3 mm diameter mandrel, that is within a range of from 0.005 dB to 0.35 dB and, (ii) when looped 1 turn around a 5 mm diameter mandrel, that is within a range of from 0.000010 dB to 0.0050 dB, (b) the optical fiber exhibits a LP11 bending loss for electromagnetic radiation having a wavelength within a range of from 1260 nm to 1360 nm, (i) when bent 1 turn around a 3 mm diameter mandrel, that is within a range of from 2.00 dB to 17.0 dB and, (ii) when bent 1 turn around a 5 mm diameter mandrel, that is within a range of from 0.010 dB to 1.00 dB, (c) the optical fiber exhibits a LP01 bending loss for electromagnetic radiation having a wavelength within a range of from 1530 nm to 1565 nm, (i) when looped 1 turn around a 3 mm diameter mandrel, that is within a range of from 0.010 dB to 2.50 dB, and (ii) when looped 1 turn around a 5 mm diameter mandrel, that is within a range of from 0.005 dB to 0.05 dB, and (d) the optical fiber exhibits a LP11 bending loss for electromagnetic radiation having a wavelength within a range of from 1530 nm to 1565 nm, (i) when looped 1 turn around a 3 mm diameter mandrel that is within a range of from 10.00 dB to 35.00 dB, and (ii) when looped 1 turn around a 5 mm diameter mandrel, that is within a range of from 1.00 dB to 6.00 dB.

According to a second aspect of the present disclosure, the optical fiber of the first aspect is presented, wherein the outer radius (r₁) of the core region is within a range of from 4.5 μm to 6.1 μm.

According to a third aspect of the present disclosure, the optical fiber of any one of the first through second aspects further comprises: an inner cladding region surrounding the core region and disposed between the core region and the depressed index cladding region, the inner cladding region comprising (i) a relative refractive index (Δ₂) within a range of from −0.05% to 0.05% and (ii) an outer radius (r₂) from the axis of the optical fiber that is within a range of from 5.0 μm to 17 μm.

According to a fourth aspect of the present disclosure, the optical fiber of any one of the first through third aspects is presented, wherein the first outer cladding region further comprises an outer radius (r₄) from the axis of the optical fiber that defines a terminal outer surface of all glass-based cladding regions of the optical fiber, the outer radius (r₄) being less than or equal to 40 μm.

According to a fifth aspect of the present disclosure, the optical fiber of the fourth aspect is presented, wherein the outer radius (r₄) of the first outer cladding region is within a range of from 30 μm to 40 μm.

According to a sixth aspect of the present disclosure, the optical fiber of any one of the first through fifth aspects further comprises: a second outer cladding region surrounding the first outer cladding region, the second outer cladding region comprising (i) silica glass doped with 4 wt % to 20 wt % TiO₂, (ii) an outer radius (r₅) within a range of from 33 μm to 70 μm, and (iii) a radial thickness (T_{M}) within a range of from 3 μm to 30 μm.

According to a seventh aspect of the present disclosure, the optical fiber of the sixth aspect is presented, wherein the outer radius (r₅) of the second outer cladding from the axis of the optical fiber is within a range of from 33 μm to 55 μm.

According to an eighth aspect of the present disclosure, the optical fiber of any one of the sixth through seventh aspects is presented, wherein the radial thickness (T_{M}) of the second outer cladding layer is within a range of from 5 μm to 15 μm.

According to a ninth aspect of the present disclosure, the optical fiber of any one of the first through eighth aspects is presented, wherein the relative refractive index (Δ₁ₘₐₓ) of the core region is within a range of from 0.35% to 0.55%.

According to a tenth aspect of the present disclosure, the optical fiber of the ninth aspect is presented, wherein the relative refractive index (Δ₁ₘₐₓ) of the core region is within a range of from 0.375% to 0.425%.

According to an eleventh aspect of the present disclosure, the optical fiber of any one of the first through tenth aspects is presented, wherein the α value that the core region exhibits is within a range of from 7 to 21.

According to a twelfth aspect of the present disclosure, the optical fiber of the eleventh aspect is presented, wherein the α value that the core region exhibits is within a range of from 7 to 9.

According to a thirteenth aspect of the present disclosure, the optical fiber of any one of the first through twelfth aspects is presented, wherein the absolute value of the trench volume of the depressed index cladding region is within a range of from 70%-μm² to 115%-μm².

According to a fourteenth aspect of the present disclosure, the optical fiber of any one of the first through thirteenth aspects is presented, wherein the optical fiber exhibits a mode field diameter for electromagnetic radiation having a wavelength of 1310 nm (MFD₁₃₁₀) within a range of from 8.0 μm to 9.5 μm.

According to a fifteenth aspect of the present disclosure, the optical fiber of any one of the first through fourteenth aspects is presented, wherein the optical fiber exhibits a mode field diameter for electromagnetic radiation having a wavelength of 1550 nm (MFD₁₅₅₀) within a range of from 8.0 μm to 10.5 μm.

According to a sixteenth aspect of the present disclosure, the optical fiber of any one of the first through fifteenth aspects is presented, wherein the optical fiber exhibits a cutoff wavelength, for the fundamental mode (LP01), for electromagnetic radiation having a wavelength within a range of from 1450 nm to 1675 nm.

According to a seventeenth aspect of the present disclosure, a micro-optic device comprises: (1) a photonics device; and (2) an optical fiber comprising: (a) a first end coupled to the photonics device; (b) a second end; (c) one or more loops between the first end and the second end, the one or more loops comprising a loop diameter within a range of from 2.5 mm and 5.5 mm; (d) a first outer cladding region comprising a no-slope portion where a refractive index of the first outer cladding region is substantially constant as a function of radius from an axis of the optical fiber, wherein the no-slope portion defines a 0% baseline (Δ₀) for relative refractive indices; (e) a core region surrounded by the first outer cladding region, the core region comprising (i) an outer radius (r₁) within a range of from 4.0 μm to 6.5 μm from the axis of the optical fiber and (ii) a maximum relative refractive index (Δ₁ₘₐₓ) within a range of from 0.3% to 0.6%, the core region exhibiting an α value that is greater than or equal to 5; and (f) a depressed index cladding region surrounding the core region and surrounded by the first outer cladding region, the depressed index cladding region comprising (i) an outer radius (r₃) from the axis of the optical fiber within a range of from 14 μm to 28 μm, (ii) a relative refractive index (Δ₃) within a range of from −0.45% to −0.30%, and (iii) a trench volume (V_{T}) that is within a range of from 65%-μm² to 140%-μm².

According to an eighteenth aspect of the present disclosure, the micro-optic device of the seventeenth aspect is presented, wherein the photonics device is a silicon photonics device.

According to a nineteenth aspect of the present disclosure, the micro-optic device of any one of the seventeenth through eighteenth aspects is presented, wherein the photonics device is selected from the group consisting of a transceiver, an array of waveguide gratings, an interposer, a modulator, a photodetector, a switch, a delay line, a filter, and a biosensor.

According to a twentieth aspect of the present disclosure, the micro-optic device of any one of the seventeenth through nineteenth aspects is presented, wherein the outer radius (r₁) of the core region of the optical fiber from the axis of the optical fiber is within a range of from 4.5 μm to 6.1 μm.

According to a twenty-first aspect of the present disclosure, the micro-optic device of any one of the seventeenth through twentieth aspects is presented, wherein the optical fiber further comprises: an inner cladding region surrounding the core region and disposed between the core region and the depressed index cladding region, the inner cladding region comprising (i) a relative refractive index (Δ₂) within a range of from −0.05% to 0.05% and (ii) an outer radius (r₂) from the axis of the optical fiber that is within a range of from 5.0 μm to 17 μm.

According to a twenty-second aspect of the present disclosure, the micro-optic device of any one of the seventeenth through twenty-first aspects is presented, wherein the first outer cladding region of the optical fiber further comprises an outer radius (r₄) from the axis of the optical fiber that defines a terminal outer surface of all glass-based cladding regions of the optical fiber, the outer radius (r₄) having a value of less than or equal to 40 μm.

According to a twenty-third aspect of the present disclosure, the micro-optic device of any one of the seventeenth through twenty-second aspects is presented, wherein the outer diameter (r₄) of the first outer cladding region is within a range of from 30 μm to 40 μm.

According to a twenty-fourth aspect of the present disclosure, the micro-optic device of any one of the seventeenth through twenty-third aspects is presented, wherein the optical fiber further comprises: a second outer cladding region surrounding the first outer cladding region, the second outer cladding region comprising (i) silica base glass doped with 4 wt % to 20 wt % TiO₂, (ii) an outer radius (r₅) from the axis of the optical fiber that is within a range of from 30 μm to 70 μm, and (iii) a radial thickness (T_{M}) within a range of from 3 μm to 30 μm.

According to a twenty-fifth aspect of the present disclosure, the micro-optic device of the twenty-fourth aspect is presented, wherein the outer radius (r₅) of the second outer cladding of the optical fiber from the axis of the optical fiber is within a range of from 33 μm to 55 μm.

According to a twenty-sixth aspect of the present disclosure, the micro-optic device of any one of the twenty-fourth through twenty-fifth aspects is presented, wherein the radial thickness (T_{M}) of the second outer cladding layer of the optical fiber is within a range of from 5 μm to 15 μm.

According to a twenty-seventh aspect of the present disclosure, the micro-optic device of any one of the seventeenth through twenty-sixth aspects is presented, wherein the relative refractive index (Δ₁ₘₐₓ) of the core region of the optical fiber is within a range of from 0.35% to 0.55%.

According to a twenty-eighth aspect of the present disclosure, the micro-optic device of the twenty-seventh aspect is presented, wherein the relative refractive index (Δ₁ₘₐₓ) of the core region of the optical fiber is within a range of from 0.375% to 0.425%.

According to a twenty-ninth aspect of the present disclosure, the micro-optic device of any one of the seventeenth through twenty-eighth aspects is presented, wherein the α value that the core region of the optical fiber exhibits is within a range of from 7 to 21.

According to a thirtieth aspect of the present disclosure, the micro-optic device of the twenty-ninth aspect is presented, wherein the α value that the core region of the optical fiber exhibits is within a range of from 7 to 9.

According to a thirty-first aspect of the present disclosure, the micro-optic device of any one of the seventeenth through thirtieth aspects is presented, wherein the absolute value of the trench volume of the depressed index cladding region of the optical fiber is within a range of from 70%-μm² to 115%-μm².

According to a thirty-second aspect of the present disclosure, the micro-optic device of any one of the seventeenth through thirty-first aspects is presented, wherein the optical fiber exhibits a mode field diameter for electromagnetic radiation having a wavelength of 1310 nm (MFD₁₃₁₀) within a range of from 8.0 μm to 9.5 μm.

According to a thirty-third aspect of the present disclosure, the micro-optic device of any one of the seventeenth through thirty-second aspects is presented, wherein the optical fiber exhibits a mode field diameter for electromagnetic radiation having a wavelength of 1550 nm (MFD₁₅₅₀) within a range of from 8.0 μm to 10.5 μm.

According to a thirty-fourth aspect of the present disclosure, the micro-optic device of any one of the seventeenth through thirty-third aspects is presented, wherein the optical fiber exhibits a cutoff wavelength, for the fundamental mode (LP01), for electromagnetic radiation having a wavelength within a range of from 1450 nm to 1675 nm.

According to a thirty-fifth aspect of the present disclosure, the micro-optic device of any one of the seventeenth through thirty-fourth aspect is presented, wherein (a) the loop diameter of the one or more loops is within a range of from 2.9 mm to 3.1 mm, (b) the fundamental mode (LP01) of electromagnetic radiation having a wavelength within range of from 1260 nm to 1360 nm enters the first end of the optical fiber and exits the second end of the optical fiber having been attenuated by a value within a range of from 0.005 dB/loop to 0.35 dB/loop, and (c) the first higher order mode (LP11) of electromagnetic radiation having a wavelength within range of from 1260 nm to 1360 nm enters the first end of the optical fiber and exits the second end of the optical fiber having been attenuated by a value within a range of from 2.00 dB/loop to 17.0 dB/loop.

According to a thirty-sixth aspect of the present disclosure, the micro-optic device of any one of the seventeenth through thirty-fifth aspects is presented, wherein (a) the loop diameter is within a range of from 4.9 mm to 5.1 mm, (b) the fundamental mode (LP01) of electromagnetic radiation having a wavelength within range of from 1260 nm to 1360 nm enters the first end of the optical fiber and exits the second end of the optical fiber having been attenuated by a value within a range of from 0.000010 dB/loop to 0.0050 dB/loop, and (c) the first higher order mode (LP11) of electromagnetic radiation having a wavelength within range of from 1260 nm to 1360 nm enters the first end of the optical fiber and exits the second end of the optical fiber having been attenuated by a value within a range of from 0.010 dB/loop to 1.00 dB/loop.

According to a thirty-seventh aspect of the present disclosure, the micro-optic device of any one of seventeenth through thirty-sixth aspects is presented, wherein (a) the loop diameter is within a range of from 2.9 mm to 3.1 mm, (b) the fundamental mode (LP01) of electromagnetic radiation having a wavelength within a range of from 1530 nm to 1565 nm enters the first end of the optical fiber and exits the second end of the optical fiber having been attenuated by a value within a range of from 0.010 dB/loop to 2.50 dB/loop, and (c) the first higher order mode (LP11) of electromagnetic radiation having a wavelength within a range of from 1530 nm to 1565 nm enters the first end of the optical fiber and exits the second end of the optical fiber having been attenuated by a value within a range of from 10.00 dB/loop to 35.00 dB/loop.

According to a thirty-eighth aspect of the present disclosure, the micro-optic device of any one of the seventeenth through thirty-seventh aspects is presented, wherein (a) the loop diameter is within a range of from 4.9 mm to 5.1 mm, (b) the fundamental mode (LP01) of electromagnetic radiation having a wavelength within a range of from 1530 nm to 1565 nm enters the first end of the optical fiber and exits the second end of the optical fiber having been attenuated by a value within a range of from 0.005 dB/loop to 0.050 dB/loop, and (c) the first higher order mode (LP11) of electromagnetic radiation having wavelength within a range of from 1530 nm to 1565 nm enters the first end of the optical fiber and exits the second end of the optical fiber having been attenuated by a value within a range of from 1.00 dB/loop to 6.00 dB/loop.

According to a thirty-ninth aspect of the present disclosure, a method of suppressing a first higher order mode (LP11) of optical fiber propagation comprises: (a) transmitting electromagnetic radiation comprising a fundamental mode (LP01) and a first higher order mode (LP11) of optical fiber propagation at a first power ratio (P_{LP01-1}/P_{LP11-1}) into a first end of an optical fiber, the optical fiber further comprising a second end and one or more loops between the first end and the second end, the one or more loops comprising a loop diameter within a range of from 2.5 mm and 5.5 mm; and (b) transmitting the electromagnetic radiation out of the second end of the optical fiber, the electromagnetic radiation transmitted out of the second end of the optical fiber at a second power ratio (P_{LP01-2}/P_{LP11-2}), wherein, the one or more loops is sufficient to increase the second power ratio (P_{LP01-2}/P_{LP11-2}) relative to the first power ratio (P_{LP01-1}/P_{LP11-1}) by a factor of at least 1.1.

According to a fortieth aspect of the present disclosure, the method of the thirty-ninth aspect is presented, wherein the optical fiber exhibits a mode field diameter for electromagnetic radiation having a wavelength of 1310 nm (MFD₁₃₁₀) within a range of from 8.0 μm to 9.5 μm.

According to a forty-first aspect of the present disclosure, the method of any one of the thirty-ninth through fortieth aspects is presented, wherein the optical fiber exhibits a mode field diameter for electromagnetic radiation having a wavelength of 1550 nm (MFD₁₅₅₀) within a range of from 8.0 μm to 10.5 μm.

According to a forty-second aspect of the present disclosure, the method of any one of the thirty-ninth through forty-first aspects is presented, wherein the one or more loops is sufficient to increase the second power ratio (P_{LP01-2}/P_{LP11-2}) relative to the first power ratio (P_{LP01-1}/P_{LP11-1}) by a factor of at least 10.

According to a forty-third aspect of the present disclosure, the method of the forty-second aspect is presented, wherein the one or more loops is sufficient to increase the second power ratio (P_{LP01-2}/P_{LP11-2}) relative to the first power ratio (P_{LP01-1}/P_{LP11-1}) by a factor of at least 100.

According to a forty-fourth aspect of the present disclosure, the method of any one of the thirty-ninth through forty-third aspects is presented, wherein the optical fiber exhibits a cutoff wavelength, for the fundamental mode (LP01) within a range of from 1450 nm to 1675 nm.

According to a forty-fifth aspect of the present disclosure, the method of any one of the thirty-ninth through forty-fourth aspect is presented, wherein (a) the electromagnetic radiation comprises a wavelength within range of from 1260 nm to 1360 nm, (b) the loop diameter is within a range of from 3.0 mm to 4.0 mm, (c) the one or more loops attenuates the first higher order mode (LP11) by a value within a range of from 5.50 dB/loop to 17.0 dB/loop, and (d) the one or more loops attenuates the fundamental mode (LP01) by a value within a range of from 0.005 dB/loop to 0.45 dB/loop.

According to a forty-sixth aspect of the present disclosure, the method of any one of one of the thirty-ninth through forty-fifth aspects is presented, wherein (a) the electromagnetic radiation comprises a wavelength within a range of from 1530 nm to 1565 nm, (b) the loop diameter is within a range of from 3.0 mm to 4.0 mm, (c) the one or more loops attenuates the first higher order mode (LP11) by a value within a range of from 10.00 dB/loop to 35.00 dB/loop, and (d) the one or more loops attenuates the fundamental mode (LP01) by a value within a range of 0.010 dB/loop to 2.50 dB/loop.

### BRIEF DESCRIPTION OF THE DRAWINGS

In the Figures:

FIG. 1 is an elevational view of an optical fiber of the present disclosure, illustrating the optical fiber include a first end where electromagnetic radiation can enter, a second end where the electromagnetic radiation can exit, and a length between the first end and the second end along which the electromagnetic radiation propagates;

FIG. 2 is an elevational view of a cross-section of the optical fiber taken through line II-II of FIG. 1, illustrating the optical fiber including a core region through which an axis of the optical fiber extends, an inner cladding region (if present) surrounding the core region, a depressed index cladding region surrounding the core region and the inner cladding region (if present), a first outer cladding region surrounding the depressed index cladding region, and (if present) a second outer cladding region surrounding the first outer cladding region;

FIG. 3 is a schematic diagram of relative refractive index (Δ) as a function of radius from the axis of the optical fiber, where the relative refractive index is relative to a no-slope portion of the refractive index of the first outer cladding region where the refractive index does not change as a function of radius from the axis;

FIG. 4 is a schematic diagram of the first end of the optical fiber coupled to a waveguide of a photonics device with the optical fiber having one or more loops between the first end and the second end;

FIG. 5 is a schematic diagram of a method of suppressing a first higher order mode (LP11) of optical fiber propagation with the optical fiber;

FIG. 6 is a graph of the relative refractive index as a function of radius from the axis for an optical fiber of Comparative Example 1;

FIG. 7 is a graph of the relative refractive index as a function of radius from the axis for an optical fiber of Comparative Example 2;

FIG. 8, pertaining to Example 6, is a graph plotting failure probability as a function of the terminal diameter of the cladding of the optical fiber, the number of loops between the first end and the second end of the optical fiber, and the loop diameter, for a cladding made entirely of SiO₂;

FIG. 9A, pertaining to Example 7A, is a graph plotting failure probability as a function of the terminal diameter of the cladding of the optical fiber, the number of loops between the first end and the second end of the optical fiber, and the loop diameter, for a cladding made of SiO₂ doped with TiO₂;

FIG. 9B, pertaining to Example 7B, is a graph plotting failure probability as a function of the terminal diameter of the cladding of the optical fiber, the number of loops between the first end and the second end of the optical fiber, and the loop diameter, for a cladding made of SiO₂ doped with TiO₂;

FIG. 10A, pertaining to Example 8A, is a graph plotting failure probability as a function of the terminal diameter of the cladding of the optical fiber, the number of loops between the first end and the second end of the optical fiber, and the loop diameter, for a cladding made of SiO₂ doped with TiO₂;

FIG. 10B, pertaining to Example 8B, is a graph plotting failure probability as a function of the terminal diameter of the cladding of the optical fiber, the number of loops between the first end and the second end of the optical fiber, and the loop diameter, for a cladding made of SiO₂ doped with TiO₂;

FIG. 11A, pertaining to Example 9A, is a graph plotting failure probability as a function of the terminal diameter of the cladding of the optical fiber, the number of loops between the first end and the second end of the optical fiber, and the loop diameter, for a cladding made of SiO₂ doped with TiO₂;

FIG. 11B, pertaining to Example 9B, is a graph plotting failure probability as a function of the terminal diameter of the cladding of the optical fiber, the number of loops between the first end and the second end of the optical fiber, and the loop diameter, for a cladding made of SiO₂ doped with TiO₂; and

FIG. 12, pertaining to Examples 11 through 14, is a graph plotting relative refractive index as a function of radius from the axis of the optical fiber.

### DETAILED DESCRIPTION

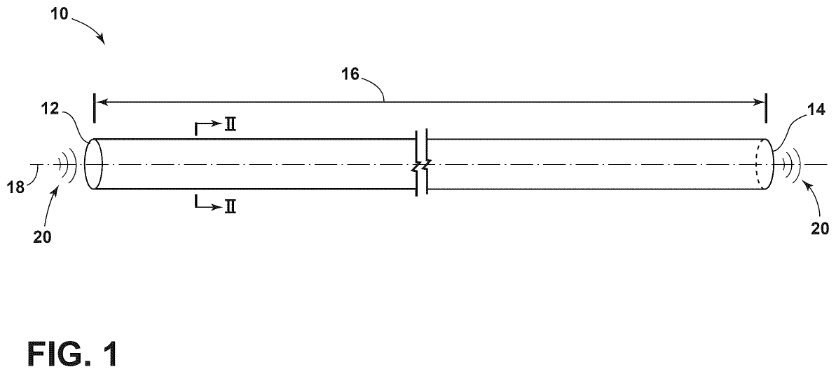

Referring now to FIG. 1, an optical fiber 10 includes a first end 12, a second end 14, and a length 16 therebetween. The optical fiber 10 further includes an axis 18 that is the radial center of the optical fiber 10 and extends the length 16 of the optical fiber 10. In general terms, the optical fiber 10 is a waveguide that transmits electromagnetic radiation 20 that enters the first end 12, through the length 16 of the optical fiber 10, and out of the optical fiber 10 at the second end 14. The length 16 of the optical fiber 10 is not particularly limited and depends on the application. Examples of the length 16 include less than 5 mm, 5 mm, 1 cm, 1 m, 100 m, 500 m, 1 km, 1 kkm, 10 kkm, or greater than 10 kkm, or within any range bound by any two of those values (e.g., from 5 mm to 1 kkm, from 1 cm to 1 m, and so on).

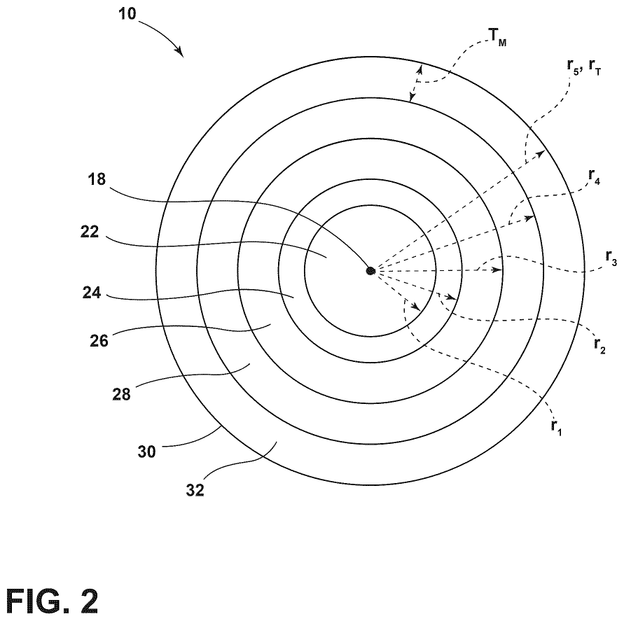

Referring now additionally to FIG. 2, the optical fiber 10 includes a core region 22. The axis 18 of the optical fiber 10 extends through the center of the core region 22. The core region 22 is where the electromagnetic radiation 20 propagates from the first end 12 to the second end 14 along the length 16 of the optical fiber 10. The core region 22 extends radially from the axis 18 to an outer radius (r₁) from the axis 18. In embodiments, the outer radius (r₁) is within a range of from 4.0 μm to 6.5 μm. In embodiments, the outer radius (r₁) is 4.0 μm, 4.1 μm, 4.2 μm, 4.3 μm, 4.4 μm, 4.5 μm, 4.6 μm, 4.7 μm, 4.8 μm, 4.9 μm, 5.0 μm, 5.1 μm, 5.2 μm, 5.3 μm, 5.4 μm, 5.5 μm, 5.6 μm, 5.7 μm, 5.8 μm, 5.9 μm, 6.0 μm, or 6.1 μm, or within any range bound by any two of those values (e.g., from 4.1 μm to 6.1 μm, from 4.5 μm to 6.0 μm, and so on). The outer radius (r₁) can be less than 4.0 μm or greater than 6.1 μm.

In embodiments, the optical fiber 10 further includes an inner cladding region 24 surrounding the core region 22. The inner cladding region 24, if included, extends radially from the outer radius (r₁) of the core region 22 to an outer radius (r₂) from the axis 18. In embodiments, the outer radius (r₂) is within a range of from 5.0 μm to 17 μm. In embodiments, the outer radius (r₂) is 5.0 μm, 5.5 μm, 6.0 μm, 6.5 μm, 7.0 μm, 7.5 μm, 8.0 μm, 8.5 μm, 9.0 μm, 9.5 μm, 10.0 μm, 10.5 μm, 11.0 μm, 11.5 μm, 12.0 μm, 12.5 μm, 13.0 μm, 13.5 μm, 14.0 μm, 14.5 μm, 15.0 μm, 15.5 μm, 16.0 μm, 16.5 μm, or 17.0 μm, or within any range bound by any two of those values (e.g., from 6.0 μm to 11.5 μm, from 7.0 μm to 13.0 μm, and so on). The outer radius (r₁) can be less than 5.0 μm or greater than 17 μm.

The optical fiber 10 further includes a depressed index cladding region 26. The depressed index cladding region 26 surrounds the core region 22. The depressed index cladding region 26 additionally surrounds the inner cladding region 24 if the inner cladding region 24 is present. The depressed index cladding region 26 extends radially from the outer radius (r₁) of the core region 22 to an outer radius (r₃) from the axis 18, or from the outer radius (r₂) of the inner cladding region 24, if present, to the outer radius (r₃). In embodiments, the outer radius (r₃) is within a range of from 14 μm to 28 μm. In embodiments, the outer radius (r₃) is 14 μm, 15 μm, 16 μm, 17 μm, 18 μm, 19 μm, 20 μm, 21 μm, 22 μm, 23 μm, 24 μm, 25 μm, 26 μm, 27 μm, or 28 μm, or within any range bound by any two of those values (e.g., from 16 μm to 24 μm, from 18 μm to 22 μm, and so on). The outer radius (r₃) can be less than 14 μm or greater than 28 μm.

The optical fiber 10 further includes a first outer cladding region 28. The first outer cladding region 28 surrounds the core region 22, the inner cladding region 24 (if present), and the depressed index cladding region 26. The first outer cladding region 28 extends radially from the outer radius (r₃) of the depressed index cladding region 26 to an outer radius (r₄) from the axis 18. In embodiments, the outer radius (r₄) of the first outer cladding region 28 defines a terminal outer surface 30 of all glass-based cladding regions of the optical fiber 10 (e.g., the inner cladding region 24, the depressed index cladding region 26, and the first outer cladding region 28). In such instance, the outer radius (r₄) of the first outer cladding region 28 is a terminal outer radius (r_{T}) of the all glass-based cladding regions of the optical fiber 10. In embodiments, the outer radius (r₄) is less than or equal to 50 μm or less than or equal to 40 μm. In embodiments the outer radius (r₄) of the first outer cladding region 28 is within a range of from 30 μm to 40 μm. In embodiments, the outer radius (r₄) is 30 μm, 31 μm, 32 μm, 33 μm, 34 μm, 35 μm, 36 μm, 37 μm, 38 μm, 39 μm, or 40 μm, or within any range bound by any two of those values (e.g., from 31 μm to 39 μm, from 33 μm to 40 μm, and so on). The outer radius (r₄) can be less than 30 μm or greater than 0 μm or greater than 50 μm. The glass-based cladding regions help propagate the electromagnetic radiation 20 from the first end 12 to the second end 14, within the core region 22, through total internal reflection.

In embodiments, the optical fiber 10 further includes a second outer cladding region 32. The second outer cladding region 32 surrounds the first outer cladding region 28. The second outer cladding region 32 can impart mechanical strength to the optical fiber 10 and avoid structural imperfections that bending of the optical fiber 10 can cause. In embodiments, the second outer cladding region 32 is silica glass doped with TiO₂. In embodiments, the silica glass is doped with 4 wt % to 20 wt % TiO₂. In embodiments, the silica glass is doped with 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt % TiO₂, or within any range of TiO₂ bound by any two of those values (e.g., from 7 wt % to 19 wt %, from 5 wt % to 15 wt %, and so on).

In embodiments, the second outer cladding region 32 extends radially from the outer radius (r₄) of the first outer cladding region 28 to an outer radius (r₅) from the axis 18. In embodiments, the outer radius (r₅) of the second outer cladding region 32, if present, defines the terminal outer surface 30 of all glass-based cladding regions of the optical fiber 10 (e.g., the inner cladding region 24, the depressed index cladding region 26, the first outer cladding region 28, and the second outer cladding region 32) and is the terminal outer radius (r_{T}) of the all glass-based cladding regions of the optical fiber 10. In embodiments, the outer radius (r₅) is less than or equal to 70 μm. In embodiments the outer radius (r₅) of the second outer cladding region 32 is within a range of from 33 μm to 70 μm. In embodiments, the outer radius (r₅) is 33 μm, 35 μm, 40 μm, 45 μm, 50 μm, 55 μm, 60 μm, 65 μm, or 70 μm, or within any range bound by any two of those values (e.g., from 33 μm to 55 μm, from 45 μm to 60 μm, and so on). The outer radius (r₅) can be less than 33 μm or greater than 70 μm.

The second outer cladding region 32 has a radial thickness (T_{M}). The radial thickness (T_{M}) is the radial distance between the outer radius (r₄) of the first outer cladding region 28 and the outer radius (r₅) of the second outer cladding region 32. In embodiments, the radial thickness (T_{M}) is within a range of from 3 μm to 30 μm. In embodiments, the radial thickness (T_{M}) is 3 μm, 5 μm, 7 μm, 9 μm, 11 μm, 13 μm, 15 μm, 17 μm, 19 μm, 21 μm, 23 μm, 25 μm, 27 μm, 29 μm, or 30 μm, or within any range bound by any two of those values (e.g., from 5 μm to 15 μm, from 9 from 5 μm to 19 μm, and so on).

As mentioned, the second outer cladding region 32 including TiO₂ can help improve the mechanical reliability of the optical fiber 10 when looped, such as to form one or more loops 34 between the first end 12 and the second end 14 along the length 16 of the optical fiber 10. Another way to improve mechanical reliability of the optical fiber 10 when bent or looped is to make the terminal outer radius (r_{T}) of the all-glass claddings regions, whether the outer radius (r₄) of the first outer cladding region 28 or the outer radius (r₅) of the second outer cladding region 32 when included, to be less than or equal to 62.5 μm. In embodiments, the terminal outer radius (r_{T}) of the claddings regions is 30 μm, 32.5 μm, 35 μm, 37.5 μm, 40 μm, 42.5 μm, 45 μm, 47.5 μm, 50 μm, 52.5 μm, 55 μm, 57.5 μm, 60 μm, or 62.5 μm, or within any range bound by any two of those values (e.g., from 30 μm, to 62.5 μm, from 35 μm to 50 μm, and so on). In embodiments, the optical fiber 10 does not include the second outer cladding region 32 with TiO₂, and the outer radius (r₄) of the first outer cladding region 28 is the terminal outer radius (r_{T}) of the all-glass cladding regions. In such embodiments, the terminal outer radius (r_{T}) is less than or equal to 40 μm or less than or equal to 50 μm.

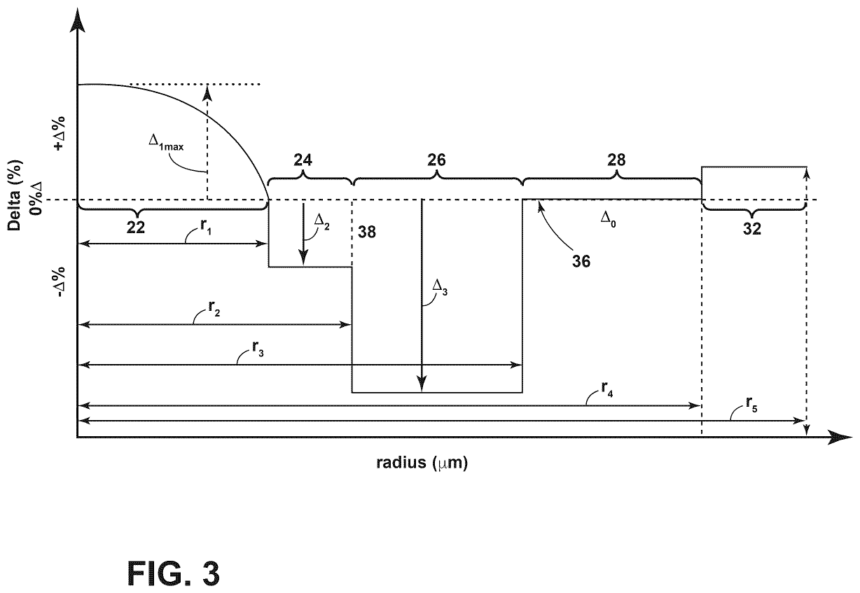

Referring now additionally to FIG. 3, each of the core region 22, the inner cladding region 24 (if present), the depressed index cladding region 26, the first outer cladding region 28, and the second outer cladding region 32 (if present) have an index of refraction or range thereof. The first outer cladding region 28 includes a no-slope portion 36 where the first outer cladding region 28 has a refractive index that is substantially constant as a function of the outer radius (r₄) from the axis 18 of the optical fiber 10. “Substantially constant” here means that the refractive index deviates from an average value throughout the substantially constant portion by less than ±5%. “Substantially constant” includes manufacturing the first outer cladding region 28 to have a constant refractive index but recognizes manufacturing includes imprecision and thus a tolerance from the intended constant refractive index. The no-slope portion 36 establishes a 0% baseline (Δ₀), from which a relative refractive index profile as a function of radius from the axis 18 can be defined for the core region 22, inner cladding region 24 (if present), the depressed index cladding region 26, and the second outer cladding region 32 (if present).

The term “relative refractive index profile,” as used herein, is the relationship between the refractive index or the relative refractive index and the radius of the optical fiber 10. The term “relative refractive index,” as used herein, is defined as:

$$Δ ( r ) \% = 100 \times \frac{( {n ( r )}^{2} - {n}_{REF}^{2} )}{2 {n ( r )}^{2}} ,$$

where n(r) is the refractive index at radius r of the optical fiber 10, unless otherwise specified, and r=0 corresponds to the axis 18 of the optical fiber 10. The relative refractive index is defined at 1550 nm unless otherwise specified. In the embodiments described herein, the reference index n_{REF} is the 0% baseline (Δ₀), as described above. As used herein, the relative refractive index is represented by Δ and its values are given in units of “%,” unless otherwise specified. In cases where the refractive index of a region is less than the reference index n_{REF}, the relative refractive index percent is negative and is referred to as having a depressed region or depressed-index, and the minimum relative refractive index is calculated at the point at which the relative index is most negative unless otherwise specified. In cases where the refractive index of a region is greater than the reference index n_{REF}, the relative refractive index percent is positive, and the region can be said to be raised or to have a positive index.

The core region 22 has a relative refractive index (Δ₁)—relative to the 0% baseline (Δ₀) that the straight-line portion of the first outer cladding region 28 establishes. The relative refractive index of the core region 22 has a maximum value (Δ₁ₘₐₓ) marking the furthest deviation from the 0% baseline (Δ₀). The maximum relative refractive index (Δ₁ₘₐₓ) is within a range of from 0.3% to 0.6%. In embodiments, the maximum relative refractive index (Δ₁ₘₐₓ) is 0.3%, 0.32%, 0.34%, 0.35%, 0.36%, 0.375%, 0.38%, 0.40%, 0.42%, 0.425%, 0.44%, 0.46%, 0.48%, 0.50%, 0.52%, 0.54%, 0.55%, 0.56%, or 0.6%, or within any range bound by any two of those values (e.g., from 0.35% to 0.55%, from 0.375% to 0.425%, and so on).

As mentioned, the core region 22 extends radially from the axis 18 to the outer radius (r₁) from the axis 18. For purposes of this disclosure, the outer radius (r₁) is determined to be where the relative refractive index (Δ₁) of the core region 22 intersects with the 0% baseline (Δ₀) that the no-slope portion 36 of the first outer cladding region 28 establishes.

The core region 22 exhibits an α value that is greater than or equal to 5. The letter “α” here means a relative refractive index profile, expressed in terms of Δ which is in units of “%,” where r is the radius and which follows the equation,

$$Δ = {Δ}_{1 m ax} [ 1 - {( \frac{r}{{r}_{1}} )}^{α} ] ,$$

where Δ₁ₘₐₓ is the maximum relative refractive index, r₁ is the outer radius of the core region 22, r is in the range rᵢ≤r≤r_{f}, Δ is as defined above, rᵢ is the initial point of the α-profile (e.g., 0), r_{f} is the final point of the α-profile, and α is an exponent which is a real number. The α-value can vary from 2 to a very large value, in principle to infinity. For a graded index profile, the α-value is less than 10. The term “parabolic,” as used herein, includes substantially parabolically shaped refractive index profiles which may vary slightly from a core region 22 α value of 2.0 at one or more points in the core, as well as profiles with minor variations and/or a centerline dip. In embodiments, the α value that the core region 22 exhibits is within a range of from 7 to 21. In embodiments, the α value that the core region 22 exhibits is within a range of from 7 to 9. In embodiments, the α value is 7, 8, 9, 10, 11, 12, 13, 14, 15, 16, 17, 18, 19, 20, or 21, or within any range bound by any two of those values (e.g., from 11 to 20, from 8 to 12, and so on).

To obtain maximum relative refractive index Δ₁ₘₐₓ values greater than or equal to 0.10%, the core region 22 of the optical fiber 100 may be up-doped with one or more dopants that increase the refractive index of silica glass. Suitable up-dopants include, without limitation, GeO₂, Al₂O₃, P₂O₅, TiO₂, Cl⁻, or the like. For example, the core 102 may be up-doped with greater than or equal to 1.8 wt. % to less than or equal to 3 wt. % GeO₂ to achieve the desired relative refractive index profile in the core region 22. As another example, the core region 22 may be up-doped with greater than or equal to 1.0 wt. % to less than or equal to 1.5 wt. % Cl⁻ to achieve the desired relative refractive index profile Δ₁ of the core region 22.

The inner cladding region 24, if present, includes a relative refractive index (Δ₂)—relative to the 0% baseline (Δ₀) that the no-slope portion 36 of the first outer cladding region 28 establishes. In embodiments, the relative refractive index (Δ₂) is within a range of from −0.05% to 0.05%. In embodiments, the relative refractive index (Δ₂) of the inner cladding region 24 is −0.05%, −0.04%, −0.03%, −0.02%, −0.01%, 0%, 0.01%, 0.02%, 0.03%, 0.04%, or 0.05%, or within range bound by any two of those values (e.g., −0.04% to 0.02%, from −0.05% to 0.03%, and so on).

The depressed index cladding region 26 includes a relative refractive index (Δ₃)—relative to the 0% baseline (Δ₀) that the straight-line portion of the first outer cladding region 28 establishes. In embodiments, the relative refractive index (Δ₃) is within a range of from −0.45% to −0.30%. In embodiments, the relative refractive index (Δ₃) is −0.45%, −0.44%, −0.43%, −0.42%, −0.41%, −0.40%, −0.39%, −0.38%, −0.37%, −0.36%, −0.35%, −0.34%, −0.33%, −0.32%, −0.31%, or −0.30%, or within any range bound by any two of those values (e.g., from −0.43% to −0.32%, from −0.40% to −0.31%, and so on).

As mentioned, the depressed index cladding region 26 extends radially from the outer radius (r₁) of the core region 22 to an outer radius (r₃) from the axis 18, or from the outer radius (r₂) of the inner cladding region 24, if present, to the outer radius (r₃). The outer radius (r₂) of the inner cladding region 24, marking the beginning of the depressed index cladding region 26, can be defined for purposes of this disclosure as where a tangent 38 of the highest downward slope of the relative refractive index (Δ₃) as a function of radius from the axis intersects with the 0% baseline (Δ₀). Similarly, the outer radius (r₃) of the depressed index cladding region 26 is defined for purposes of this disclosure as the smallest radius (not including the outer radius (r₂)) where the relative refractive index (Δ₃) again intersects with the 0% baseline (Δ₀).

The depressed index cladding region 26 may be formed from silica glass that is doped with F⁻ that decreases the index of refraction of the glass of the low-index trench. In embodiments, the depressed index cladding region 26 is formed from silica glass that is down-doped with greater than or equal to 0.7 wt. % and less than or equal to 2.5 wt. % F⁻. In some other embodiments, the depressed index cladding region 26 is formed from silica glass that is down-doped with greater than or equal 5 wt. % and less than or equal to 10 wt. % boron oxide (B₂O₃).

The depressed index cladding region 26 includes a trench volume. The radial width of a particular glass portion of an optical fiber 10 may be interrelated with a relative refractive index of the particular glass portion. Specifically, a glass portion ‘i’ with an absolute relative refractive index |Δᵢ|%, an inner radius rᵢₙ and an outer radius rₒᵤₜ may have a volume Vᵢ defined as:

$${V}_{i} = 2 {\int }_{{r}_{i n}}^{{r}_{o u t}} \vert {Δ}_{i} \vert \% ( r ) rdr$$

which may be rewritten as if |Δᵢ| is constant:

$${V}_{i} = \vert {Δ}_{i} \vert \% ( {r}_{out}^{2} - {r}_{i n}^{2} ) .$$

Accordingly, the depressed index cladding region 26 may have a trench volume (V_{T}) of:

$${V}_{T} = \vert {Δ}_{3} \vert \% ( {r}_{3}^{2} - {r}_{2}^{2} )$$

where the trench volume (V_{T}) is defined in terms of the absolute value of the relative refractive index Δ₃ of depressed index cladding region 26 and is accordingly a positive quantity.

In embodiments, the trench volume (V_{T}) that is within a range of from 65%-μm² to 140%-μm². In embodiments, the trench volume (V_{T}) is 65%-μm², 70%-μm², 75%-μm², 80%-μm², 85%-μm², 90%-μm², 95%-μm², 100%-μm², 105%-μm², 110%-μm², 115%-μm², 120%-μm², 125%-μm², 130%-μm², 135%-μm², or 140%-μm², or within any range bound by any two of those values (e.g., from 70%-μm² to 100%-μm², from 90%-μm² to 125%-μm², and so on). With the proper choice of fiber core, trench and cladding parameters, desired optical properties can be achieved.

The optical fiber 10 described above exhibits bend performance as measured for the fundamental mode (LP01) of optical fiber 10 propagation that is different than as measured for the first higher order mode (LP11) of optical fiber 10 propagation. Bend performance can be determined according to FOTP-62 (JEC-60793-1-47) by wrapping one or more loops 34 of optical fiber 10 around a mandrel with a prescribed loop diameter 40 and measuring the increase in attenuation due to the bending. The measured bend loss is the difference between the attenuation under the prescribed bend condition and the attenuation without the one or more loops 34.

More specifically, the optical fiber 10 exhibits a bending loss for the fundamental mode (LP01) of optical fiber 10 propagation having a wavelength within range of from 1260 nm to 1360 nm (e.g., 1310 nm), when bent 1 loop around a 3 mm diameter mandrel, that is within a range of from 0.005 dB to 0.35 dB. In embodiments, the bending loss for LP01 having a wavelength within range of from 1260 nm to 1360 nm (e.g., 1310 nm), when the optical fiber 10 is bent 1 loop around a 3 mm diameter mandrel, is 0.005 dB, 0.010 dB, 0.050 dB, 0.10 dB, 0.15 dB, 0.20 dB, 0.25 dB, 0.30 dB, or 0.35 dB, or within any range bound by any two of those values (e.g., from 0.010 dB to 0.10 dB, from 0.050 dB to 0.30 dB, and so on). The wavelength range of from 1260 nm to 1360 nm is referred to in the art as the O-band (or the Original band).

However, the optical fiber 10 exhibits a bending loss for the fundamental mode (LP11) of optical fiber 10 propagation having a wavelength within range of from 1260 nm to 1360 nm (e.g., 1310 nm), when bent 1 loop around a 3 mm diameter mandrel, that is within a range of from 2.00 dB to 17.0 dB. In embodiments, the bending loss for LP11 having a wavelength within range of from 1260 nm to 1360 nm (e.g., 1310 nm), when the optical fiber 10 is bent 1 loop around a 3 mm diameter mandrel, is 2.00 dB, 3.00 dB, 4.00 dB, 5.00 dB, 6.00 dB, 7.00 dB, 8.00 dB, 9.00 dB, 10.0 dB, 11.0 dB, 12.0 dB, 13.0 dB, 14.0 dB, 15.0 dB, 16.0 dB, or 17.0 dB, or within any range bound by any two of those values (e.g., from 3.00 dB to 16.0 dB, from 5.00 dB to 15.0 dB, and so on).

The optical fiber 10 exhibits a bending loss for the fundamental mode (LP01) of optical fiber 10 propagation having a wavelength within range of from 1260 nm to 1360 nm (e.g., 1310 nm), when bent 1 loop around a 5 mm diameter mandrel, that is within a range of from 0.000010 dB to 0.0050 dB. In embodiments, the bending loss for LP01 having a wavelength within range of from 1260 nm to 1360 nm (e.g., 1310 nm), when the optical fiber 10 is bent 1 loop around a 5 mm diameter mandrel, is 0.000010 dB, 0.000050 dB, 0.00010 dB, 0.00050 dB, 0.0010 dB, 0.0050 dB, 0.0100 dB, or 0.0050 dB, or within any range bound by any two of those values (e.g., from 0.000050 dB to 0.0100 dB, from 0.00010 dB to 0.0050 dB, and so on).

However, the optical fiber 10 exhibits a bending loss for the fundamental mode (LP11) of optical fiber 10 propagation having a wavelength within range of from 1260 nm to 1360 nm (e.g., 1310 nm), when bent 1 loop around a 5 mm diameter mandrel, that is within a range of from 0.010 dB to 1.00 dB. In embodiments, the bending loss for LP11 having a wavelength within range of from 1260 nm to 1360 nm (e.g., 1310 nm), when the optical fiber 10 is bent 1 loop around a 5 mm diameter mandrel, is 0.010 dB, 0.025 dB, 0.050 dB, 0.075 dB, 0.100 dB, 0.250 dB, 0.500 dB, 0.750 dB, or 1.00 dB, or within any range bound by any two of those values (e.g., from 0.025 dB to 0.750 dB, from 0.050 dB to 1.00 dB, and so on).

The optical fiber 10 exhibits a bending loss for the fundamental mode (LP01) of optical fiber 10 propagation having a wavelength within a range of from 1530 nm to 1565 nm (e.g., 1550 nm), when bent 1 loop around a 3 mm diameter mandrel, that is within a range of from 0.010 dB to 2.50 dB. In embodiments, the bending loss for LP01 having a wavelength within a range of from 1530 nm to 1565 nm (e.g., 1550 nm), when the optical fiber 10 is bent 1 loop around a 3 mm diameter mandrel, is 0.010 dB, 0.050 dB, 0.10 dB, 0.50 dB, 1.00 dB, 1.25 dB, 1.50 dB, 1.75 dB, 2.00 dB, 2.25 dB, or 2.50 dB, or within any range bound by any two of those values (e.g., from 0.010 dB to 1.75 dB, from 0.050 dB to 2.25 dB, and so on). The wavelength range of from 1530 nm to 1565 nm is referred to in the art as the C-band (or Conventional band).

However, the optical fiber 10 exhibits a bending loss for the fundamental mode (LP11) of optical fiber 10 propagation having a wavelength within a range of from 1530 nm to 1565 nm (e.g., 1550 nm), when bent 1 loop around a 3 mm diameter mandrel, that is within a range of from 10.00 dB to 35.00 dB. In embodiments, the bending loss for LP11 having a wavelength within a range of from 1530 nm to 1565 nm (e.g., 1550 nm), when the optical fiber 10 is bent 1 loop around a 3 mm diameter mandrel, is 10.00 dB, 11.00 dB, 12.00 dB, 13.00 dB, 14.00 dB, 15.00 dB, 16.00 dB, 17.00 dB, 18.00 dB, 19.00 dB, 20.00 dB, 21.00 dB, 22.00 dB, 23.00 dB, 24.00 dB, 25.00 dB, 26.00 dB, 27.00 dB, 28.00 dB, 29.00 dB, 30.00 dB, 31.00 dB, 32.00 dB, 33.00 dB, 34.00 dB, or 35.00 dB, or within any range bound by any two of those values (e.g., from 11.00 dB to 27.0 dB, from 28.00 dB to 33.0 dB, and so on).

The optical fiber 10 exhibits a bending loss for the fundamental mode (LP01) of optical fiber 10 propagation having a wavelength within a range of from 1530 nm to 1565 nm (e.g., 1550 nm), when bent 1 loop around a 5 mm diameter mandrel, that is within a range of from 0.005 dB to 0.050 dB. In embodiments, the bending loss for LP01 having a wavelength within a range of from 1530 nm to 1565 nm (e.g., 1550 nm), when the optical fiber 10 is bent 1 loop around a 5 mm diameter mandrel, is 0.005 dB, 0.008 dB, 0.010 dB, 0.020 dB, 0.030 dB, 0.040 dB, or 0.050 dB, or within any range bound by any two of those values (e.g., from 0.005 dB to 0.030 dB, from 0.008 dB to 0.040 dB, and so on).

However, the optical fiber 10 exhibits a bending loss for the fundamental mode (LP11) of optical fiber 10 propagation having a wavelength within a range of from 1530 nm to 1565 nm (e.g., 1550 nm), when bent 1 loop around a 5 mm diameter mandrel, that is within a range of from 1.00 dB to 6.00 dB. In embodiments, the bending loss for LP11 having a wavelength within a range of from 1530 nm to 1565 nm (e.g., 1550 nm), when the optical fiber 10 is bent 1 loop around a 5 mm diameter mandrel, is 1.00 dB, 1.50 dB, 2.00 dB, 2.50 dB 3.00 dB, 3.50 dB, 4.00 dB, 4.50 dB, 5.00 dB, 5.50 dB, or 6.00 dB, or within any range bound by any two of those values (e.g., from 1.50 dB to 3.00 dB, from 2.00 dB to 4.50 dB, and so on).

The mode field diameter is the effective size of the core region 22 through which the electromagnetic radiation 20 is propagated, marking the boundary where optical power falls to 1/e² of its peak power. The mode field diameter is a function of the wavelength, the outer radius (r₁) of the core region 22, and refractive index profile of the optical fiber 10. The mode field diameter is measured using the Peterman II method where:

$$M F D = 2 w , \\ and \\ {w}^{2} = 2 \frac{{\int }_{0}^{∞} {E}^{2} rdr}{{\int }_{0}^{∞} {( dE / dr )}^{2}} rdr$$

where E is the electric field distribution in the optical fiber 10 and r is the radius of the optical fiber 10.

In embodiments, the optical fiber 10 exhibits a mode field diameter for electromagnetic radiation 20 having a wavelength of 1310 nm (MFD₁₃₁₀) within a range of from 8.0 μm to 9.5 μm. In embodiments, the mode field diameter for electromagnetic radiation 20 having a wavelength of 1310 nm (MFD₁₃₁₀) that the optical fiber 10 exhibits is 8.0 μm, 8.1 μm, 8.2 μm, 8.3 μm, 8.4 μm, 8.5 μm, 8.6 μm, 8.7 μm, 8.8 μm, 8.9 μm, 9.0 μm, 9.1 μm, 9.2 μm, 9.3 μm, 9.4, or 9.5 μm, or within any range bound by any two of those values (e.g., from 8.2 μm to 9.5 μm, from 8.8 μm and 9.2 μm, and so on).

In embodiments, the optical fiber 10 exhibits a mode field diameter for electromagnetic radiation 20 having a wavelength of 1550 nm (MFD₁₅₅₀) within a range of from 8.0 μm to 10.5 μm. In embodiments, the mode field diameter for electromagnetic radiation 20 having a wavelength of 1550 nm (MFD₁₅₅₀) that the optical fiber 10 exhibits is 8.0 μm, 8.1 μm, 8.2 μm, 8.3 μm, 8.4 μm, 8.5 μm, 8.6 μm, 8.7 μm, 8.8 μm, 8.9 μm, 9.0 μm, 9.1 μm, 9.2 μm, 9.3 μm, 9.4 μm, 9.5 μm, 9.7 μm, 9.8 μm, 9.9 μm, 10.0 μm, 10.1 μm, 10.2 μm, 10.3 μm, 10.4 μm, or 10.5 μm, or within any range bound by any two of those values (e.g., from 8.6 μm to 9.6 μm, from 8.8 μm to 9.4 μm, and so on).

The cutoff wavelength is the shortest wavelength at which only the fundamental mode (LP01) can be supported. At wavelengths 16 longer than the cutoff wavelength, only the fundamental mode (LP01) propagates through the optical fiber 10—higher modes, including the first higher order mode (LP11), are attenuated and do not propagate through the optical fiber 10 from first end 12 to second end 14. At wavelengths shorter than the cutoff wavelength, the fundamental mode (LP01) and higher order modes, such the first higher order mode (LP11), can propagate through the optical fiber 10. The cutoff wavelength can be determined by measuring the refractive index profile of the optical fiber 10 using, for example, an IFA-100 Interferometric Fiber Analyzer from Interfiber Analysis, LLC, Sharon, MA 02067, USA. The measured core and inner cladding refractive index profile is used to calculate the theoretical cutoff wavelength as described in Single Mode Fiber Optics, Jeunhomme, pp. 39 44, Marcel Dekker, New York, 1990 assuming the inner cladding region 24 extends to infinity, irrespective of the structure of the optical fiber 10 outside the core region 22.

In embodiments, the optical fiber 10 exhibits a cutoff wavelength for the fundamental mode (LP01) that is within a range of from 1450 nm to 1675 nm. In embodiments, the cutoff wavelength that the optical fiber 10 exhibits is 1450 nm, 1475 nm, 1500 nm, 1525 nm, 1550 nm, 1575 nm, 1600 nm, 1625 nm, 1650 nm, or 1675 nm, or within any range bound by any two of those values (e.g., from 1475 nm to 1650 nm, from 1525 nm to 1675 nm, and so on).

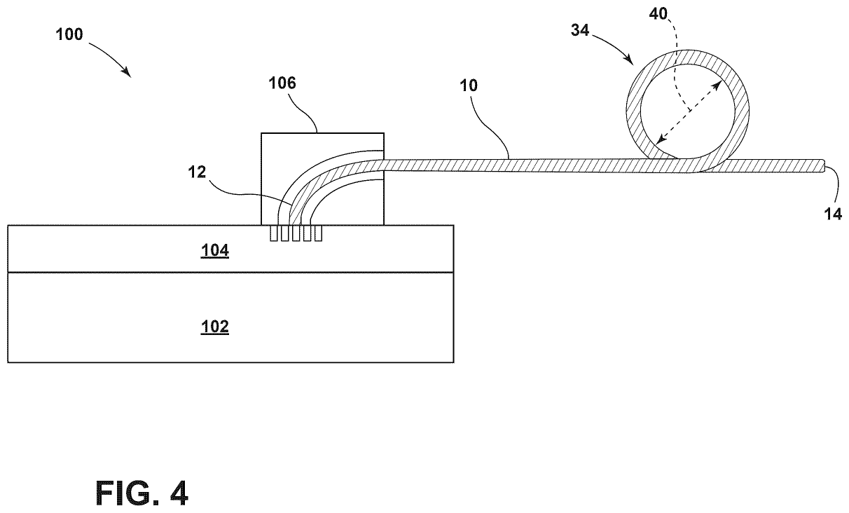

Referring now additionally to FIG. 4, the optical fiber 10 can be a component of a micro-optic device 100. The micro-optic device 100 includes a photonics device 102 and the optical fiber 10. The photonics device 102 can be any device designed to manipulate, generate, detect, or otherwise interact with photons. In embodiments, the photonics device 102 is a silicon photonics device. The silicon photonics device can be any photonics device 102 that is fabricated from silicon-based materials. Examples of the photonics device 102, which can be a silicon photonics device, include a transceiver, an array of waveguide gratings, an interposer, a modulator, a photodetector, a switch, a delay line, a filter, and a biosensor, among other possibilities. The first end 12 of the optical fiber 10 is coupled to the photonics device 102. For example, the photonics device 102 can include a waveguide 104 and a connector 106 that couples the first end 12 of the optical fiber 10 to the waveguide 104. The present disclosure is not limited to any particular photonics device 102 or connector 106 utilized.

With the micro-optic device 100, the optical fiber 10 additionally includes the one or more loops 34 between the first end 12 and the second end 14. Each of the one or more loops 34 has the loop diameter 40. The loop diameter 40 is within a range of from 2.5 mm to 5.5 mm. In embodiments, the loop diameter 40 is 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, 5.0 mm, 5.1 mm, 5.2 mm, 5.3 mm, 5.4 mm, or 5.5 mm, or within any range bound by any two of those values (e.g., from 2.8 mm to 4.2 mm, from 3.1 mm to 4.7 mm, and so on). The one of more loops 34 can number 1 loop, 2 loops, 3 loops, and so on.

In embodiments, the loop diameter 40 is within a range of from 2.9 mm to 3.1 mm. In such embodiments, the fundamental mode (LP01) of electromagnetic radiation 20 having a wavelength within range of from 1260 nm to 1360 nm (e.g., 1310 nm) enters the first end 12 of the optical fiber 10 and exits the second end 14 of the optical fiber 10 having been attenuated by a value within a range of from 0.005 dB/loop to 0.35 dB/loop. In embodiments, the fundamental mode (LP01) exits the second end 14 having been attenuated by a value of 0.005 dB/loop, 0.010 dB/loop, 0.050 dB/loop, 0.10 dB/loop, 0.15 dB/loop, 0.20 dB/loop, 0.25 dB/loop, 0.30 dB/loop, or 0.35 dB/loop, or within any range bound by any two of those values (e.g., from 0.010 dB/loop to 0.30 dB/loop, from 0.15 dB/loop to 0.25 dB/loop).

However, in such embodiments, the first higher order mode (LP11) of electromagnetic radiation 20 having a wavelength within range of from 1260 nm to 1360 nm (e.g., 1310 nm) enters the first end 12 of the optical fiber 10 and exits the second end 14 of the optical fiber 10 having been attenuated by a value within a range of from 2.00 dB/loop to 17.0 dB/loop. In embodiments, the first higher order mode (LP11) exits the second end 14 having been attenuated by a value of 2.00 dB/loop, 3.00 dB/loop, 4.00 dB/loop, 5.00 dB/loop, 6.00 dB/loop, 7.00 dB/loop, 8.00 dB/loop, 9.00 dB/loop, 10.0 dB/loop, 11.0 dB/loop, 12.0 dB/loop, 13.0 dB/loop, 14.0 dB/loop, 15.0 dB/loop, 16.0 dB/loop, or 17.0 dB/loop, or within any range bound by any two of those values (e.g., from 3.00 dB/loop to 8.00 dB/loop, from 5.00 dB/loop to 10.0 dB/loop).

As the above attenuation values reveal, at the operating wavelengths discussed herein, the one or more loops 34 attenuates the fundamental mode (LP01) but only by a small amount relative to the first higher order mode (LP11). The one or more loops 34 attenuates the first higher order mode (LP11) by a large amount relative to the fundamental mode (LP01). The consequence is that the one or more loops 34 effectively suppresses propagation of the first higher order mode (LP11) and transforms the optical fiber 10 into a single mode optical fiber 10.

In embodiments, the loop diameter 40 is within a range of from 4.9 mm to 5.1 mm. In such embodiments, the fundamental mode (LP01) of electromagnetic radiation 20 having a wavelength within range of from 1260 nm to 1360 nm (e.g., 1310 nm) enters the first end 12 of the optical fiber 10 and exits the second end 14 of the optical fiber 10 having been attenuated by a value within a range of from 0.000010 dB/loop to 0.0050 dB/loop. In embodiments, the fundamental mode (LP01) exits the second end 14 having been attenuated by a value of 0.000010 dB/loop, 0.000050 dB/loop, 0.00010 dB/loop, 0.00050 dB/loop, 0.0010 dB/loop, or 0.0050 dB/loop, or within any range bound by any two of those values (e.g., from 0.000050 dB/loop to 0.0100 dB/loop, from 0.00010 dB/loop to 0.0050 dB/loop, and so on).

However, in such embodiments, the first higher order mode (LP11) of electromagnetic radiation 20 having a wavelength within range of from 1260 nm to 1360 nm (e.g., 1310 nm) enters the first end 12 of the optical fiber 10 and exits the second end 14 of the optical fiber 10 having been attenuated by a value within a range of from 0.010 dB/loop to 1.00 dB/loop. In embodiments, the first higher order mode (LP11) exits the second end 14 having been attenuated by a value of 0.010 dB/loop, 0.025 dB/loop, 0.050 dB/loop, 0.075 dB/loop, 0.100 dB/loop, 0.250 dB/loop, 0.500 dB/loop, 0.750 dB/loop, or 1.00 dB/loop, or within any range bound by any two of those values (e.g., from 0.025 dB/loop to 0.750 dB/loop, from 0.050 dB/loop to 1.00 dB/loop, and so on).

As mentioned, in embodiments, the loop diameter 40 is within a range of from 2.9 mm to 3.1 mm. In such embodiments, the fundamental mode (LP01) of electromagnetic radiation 20 having a wavelength within a range of from 1530 nm to 1565 nm (e.g., 1550 nm) enters the first end 12 of the optical fiber 10 and exits the second end 14 of the optical fiber 10 having been attenuated by a value within a range of from 0.010 dB/loop to 2.50 dB/loop. In embodiments, the fundamental mode (LP01) exits the second end 14 having been attenuated by a value of 0.010 dB/loop, 0.050 dB/loop, 0.10 dB/loop, 0.50 dB/loop, 1.00 dB/loop, 1.25 dB/loop, 1.50 dB/loop, 1.75 dB/loop, 2.00 dB/loop, 2.25 dB/loop, or 2.50 dB/loop, or within any range bound by any two of those values (e.g., from 0.010 dB/loop to 1.75 dB/loop, from 0.050 dB/loop to 2.25 dB/loop, and so on).

However, in such embodiments, the first higher order mode (LP11) of electromagnetic radiation 20 having a wavelength within a range of from 1530 nm to 1565 nm (e.g., 1550 nm) enters the first end 12 of the optical fiber 10 and exits the second end 14 of the optical fiber 10 having been attenuated by a value within a range of from 10.00 dB/loop to 35.00 dB/loop. In embodiments, the first higher order mode (LP11) exits the second end 14 having been attenuated by a value of 10.00 dB/loop, 11.00 dB/loop, 12.00 dB/loop, 13.00 dB/loop, 14.00 dB/loop, 15.00 dB/loop, 16.00 dB/loop, 17.00 dB/loop, 18.00 dB/loop, 19.00 dB/loop, 20.00 dB/loop, 21.00 dB/loop, 22.00 dB/loop, 23.00 dB/loop, 24.00 dB/loop, 25.00 dB/loop, 26.00 dB/loop, 27.00 dB/loop, 28.00 dB/loop, 29.00 dB/loop, 30.00 dB/loop 31.00 dB/loop, 32.00 dB/loop, 33.00 dB/loop, 34.00 dB/loop, or 35.00 dB/loop, or within any range bound by any two of those values (e.g., from 11.00 dB/loop to 27.0 dB/loop, from 28.00 dB/loop to 33.0 dB/loop, and so on).

In embodiments, the loop diameter 40 is within a range of from 4.9 mm to 5.1 mm. In such embodiments, the fundamental mode (LP01) of electromagnetic radiation 20 having a wavelength within a range of from 1530 nm to 1565 nm (e.g., 1550 nm) enters the first end 12 of the optical fiber 10 and exits the second end 14 of the optical fiber 10 having been attenuated by a value within a range of from 0.005 dB/loop to 0.05 dB/loop. In embodiments, the fundamental mode (LP01) exits the second end 14 having been attenuated by a value of 0.005 dB/loop, 0.008 dB/loop, 0.010 dB/loop, 0.020 dB/loop, 0.030 dB/loop, 0.040 dB/loop, or 0.050 dB/loop, or within any range bound by any two of those values (e.g., from 0.005 dB/loop to 0.030 dB/loop, from 0.008 dB/loop to 0.040 dB/loop, and so on).

However, in such embodiments, the first higher order mode (LP11) of electromagnetic radiation 20 having a wavelength within a range of from 1530 nm to 1565 nm (e.g., 1550 nm) enters the first end 12 of the optical fiber 10 and exits the second end 14 of the optical fiber 10 having been attenuated by a value within a range of from 1.00 dB/loop to 6.0 dB/loop. In embodiments, the first higher order mode (LP11) exits the second end 14 having been attenuated by a value of 1.00 dB/loop, 1.50 dB/loop, 2.00 dB/loop, 2.50 dB/loop, 3.00 dB/loop, 3.50 dB/loop, 4.00 dB/loop, 4.50 dB/loop, 5.00 dB/loop, 5.50 dB/loop, or 6.00 dB/loop, or within any range bound by any two of those values (e.g., from 1.50 dB/loop to 3.00 dB/loop, from 2.00 dB/loop to 4.50 dB/loop, and so on).

Whether the wavelength of electromagnetic radiation 20 entering the first end 12 of the optical fiber 10 has a wavelength within range of from 1260 nm to 1360 nm (e.g., 1310 nm) or a wavelength within a range of from 1530 nm to 1565 nm (e.g., 1550 nm), the one or more loops 34 attenuates the first higher order mode (LP11) to a much larger degree than the one or more loops 34 attenuates the fundamental mode (LP01) of the electromagnetic radiation 20. The one or more loops 34 effectively transforms the optical fiber 10 into a single mode optical fiber 10, when the optical fiber 10 would otherwise not be. This is beneficial because the design considerations for the micro-optic device 100 can call for the one or more loops 34 to exist. However, without the optical fiber 10 of the present disclosure, the one or more loops 34 may attenuate the fundamental mode (LP01) to about the same degree as the first higher order mode (LP11), which would render the optical fiber 10 unsuitable for its intended application.

Further, the one or more loops 34 attenuating the first higher order mode (LP11) to a much larger degree than the fundamental mode (LP01) permits the optical fiber 10 to be utilized in situations where the cutoff wavelength is longer than the operating wavelength. Typically, the optical fiber 10 is chosen to have a cutoff wavelength that is shorter than the operating wavelength so that the first higher order mode (LP11) is not propagated, and multiple-path interference is avoided. However, with the one or more loops 34 and the associated suppression of the first higher order mode (LP11), the cutoff wavelength of the optical fiber 10 need not be less than the operating wavelength.

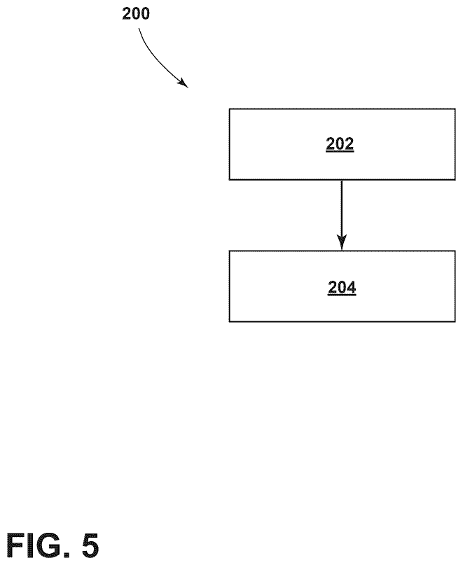

In that regard, referring now additionally to FIG. 5, a method 200 of suppressing a first higher order mode (LP11) of optical fiber 10 propagation is herein disclosed. At a step 202, the method 200 includes transmitting the electromagnetic radiation 20 that includes both the fundamental mode (LP01) and first higher order mode (LP11) of optical fiber 10 propagation at a first power ratio (P_{LP01-1}/P_{LP11-1}) into the first end 12 of the optical fiber 10. The first power ratio (P_{LP01-1}/P_{LP11-1}) is the ratio of a power of the fundamental mode (LP01) entering the first end 12 of the optical fiber 10 (P_{LP01-1}) to a power of the first higher order mode (LP11) entering the first end 12 of the optical fiber 10 (P_{LP11-1}). The optical fiber 10 includes the one or more loops 34, and at least a portion of the electromagnetic radiation 20 that enters the first end 12 of the optical fiber 10 propagates through the one or more loops 34 of the optical fiber 10.

At a step 204, the method 200 further includes transmitting the electromagnetic radiation 20 out of the second end 14 of the optical fiber 10. The electromagnetic radiation 20 is transmitted out of the second end 14 at a second power ratio (P_{LP01-2}/P_{LP11-2}). The second power ratio (P_{LP01-2}/P_{LP11-2}) is the ratio of a power of the fundamental mode (LP01) exiting the second end 14 of the optical fiber 10 (P_{LP01-2}) to a power of the first higher order mode (LP11) exiting the second end 14 of the optical fiber 10 (P_{LP11-2}). Because of the design of the optical fiber 10 of the present disclosure, the one or more loops 34 attenuates (e.g., reduces the power of) the first higher order mode (LP11) exiting the second end 14 of the optical fiber 10 to a greater degree than the one or more loops 34 attenuates the power of the fundamental mode (LP01) exiting the second end 14 of the optical fiber 10. Consequently, the one or more loops 34 increases the second power ratio relative to the first power ratio. In other words, the one or more loops 34 reduces the power of the fundamental mode (LP01) propagating through the optical fiber 10 less than the one or more loops 34 reduces the power of the first higher order mode (LP11) of the optical fiber 10. Thus, the power of the fundamental mode (LP01) exiting the second end 14 (P_{LP01-2}) relative to the power of the first higher order mode (LP11) exiting the second end 14 (P_{LP11-2}) is higher than the power of the fundamental mode (LP01) entering the first end 12 (P_{LP01-1}) relative to the power of the first higher order mode (LP11) entering the first end 12 (P_{LP11-1}).

The one or more loops 34 is sufficient to increase the second power ratio relative ratio (P_{LP01-2}/P_{LP11-2}) relative to the first power ratio (P_{LP01-1}/P_{LP11-1}) by a factor of at least 1.1. In embodiments, the one or more loops 34 is sufficient to increase the second power ratio (P_{LP01-2}/P_{LP11-2}) relative to the first power ratio (P_{LP01-1}/P_{LP11-1}) by a factor of at least 10. In embodiments, the one or more loops 34 is sufficient to increase the second power ratio (P_{LP01-2}/P_{LP11-2}) relative to the first power ratio (P_{LP01-1}/P_{LP11-1}) by a factor of at least 100.

In embodiments, the electromagnetic radiation 20 entering the first end 12 of the optical fiber 10 has a wavelength within a range of from 1260 nm to 1360 nm (e.g., 1310 nm), and the loop diameter 40 is within a range of from 3.0 mm to 4.0 mm. In such embodiments, the one or more loops 34 can attenuate the first higher order mode (LP11) by a value within a range of from 5.50 dB/loop to 17.0 dB/loop, while attenuating the fundamental mode (LP01) by a value within a range of only from 0.005 dB/loop to 0.45 dB/loop.

In other embodiments, the electromagnetic radiation 20 entering the first end 12 of the optical fiber 10 has a wavelength within range of from 1530 nm to 1565 nm (e.g., 1550 nm), and the loop diameter 40 is within a range of from 3.0 mm to 4.0 mm. In such embodiments, the one or more loops 34 can attenuate the first higher order mode (LP11) by a value within a range of from 10.00 dB/loop to 35.00 dB/loop, while attenuating the fundamental mode (LP01) by a value within a range of 0.010 dB/loop to 2.50 dB/loop.

### EXAMPLES

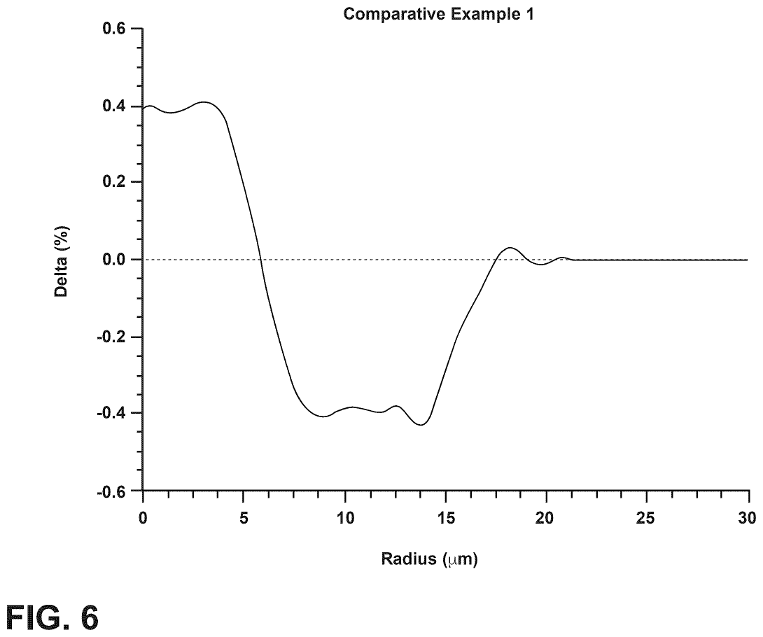

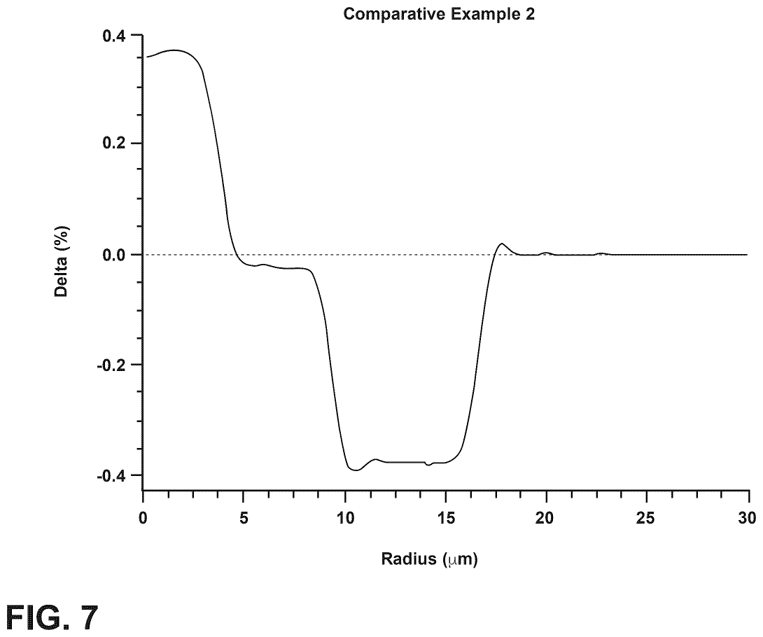

Examples 1-5 and Comparative Examples 1-2—Comparative Examples 1 and 2 are both commercial optical fibers. The relative refractive index profile of the optical fiber of Comparative Example 1 is reproduced at FIG. 6. The relative refractive index profile of the optical fiber of Comparative Example 2 is reproduced at FIG. 7. The relative refractive index profiles reveal the design of the core region and cladding regions of the optical fibers.

Examples 1-5 are computer modeled with the relative refractive index profiles established as set parameters. The relative refractive index profiles for Examples 1-5 are set forth in Table 1 below:

TABLE 1

| | Comp. | Comp. | | | | | |
|---|---|---|---|---|---|---|---|
| | Ex. 1 | Ex. 2 | Ex. 1 | Ex. 2 | Ex. 3 | Ex. 4 | Ex. 5 |
| Δ₁ (%) | See | See | 0.4 | 0.4 | 0.44 | 0.45 | 0.5 |
| r₁ (μm) | FIG. 6 | FIG. 7 | 5.7 | 5.7 | 5.6 | 5.8 | 4.65 |
| alpha | | | 8 | 8 | 8 | 8 | 20 |
| Δ₂ (%) | | | 0 | 0 | 0 | 0 | 0 |
| r₂ (μm) | | | 7 | 13 | 6.3 | 6.7 | 8.2 |
| r₃ (μm) | | | 18 | 25 | 16 | 16 | 20 |
| Δ₃ %) | | | −0.4 | −0.35 | −0.35 | −0.35 | −0.4 |
| Trench | | | 110 | 96.25 | 75.7 | 73.9 | 133.1 |
| Volume | | | | | | | |
| (%-μm²) | | | | | | | |
| Δ₄ (%) | | | 0 | 0 | 0 | 0 | 0.06 |

Various properties for the optical fibers of Comparative Examples 1 and 2 and Examples 1-5 were experimentally determined or calculated via the computer modeling. The various properties include the cutoff wavelength (“cutoff”), the mode field diameter (“MFD”) at particular wavelengths, and the bending loss for both the fundamental mode (LP01) and the first higher order mode (LP11) as a function of wavelength (1310 nm and 1550 nm) and loop diameter (3 mm and 5 mm). The experimentally determined and calculated results are set forth in Table 2 below.

TABLE 2

| | Comp. | Comp. | | | | | |
|---|---|---|---|---|---|---|---|
| | Ex. 1 | Ex. 2 | Ex. 1 | Ex. 2 | Ex. 3 | Ex. 4 | Ex. 5 |
| Cutoff (nm) | 1477 | 1156 | 1575 | 1577 | 1556 | 1638 | 1499 |
| MFD @ 1310 nm | 8.86 | 8.4739 | 9.1 | 9.1 | 8.7 | 8.9 | 8.287 |
| (μm) | | | | | | | |
| MFD @ 1550 nm | 9.4686 | 9.5666 | 9.7 | 9.7 | 9.3 | 9.5 | 9.0019 |
| (μm) | | | | | | | |
| LP01 Bending loss @ | 0.12 | 6.94 | 0.06 | 0.29 | 0.13 | 0.07 | 1.40E−02 |
| 3 mm @ 1310 nm | | | | | | | |
| (dB/turn) | | | | | | | |
| LP11 Bending loss @ | 17.81 | 28.77 | 6.16 | 12.397 | 15.6 | 8.22 | 13.7 |
| 3 mm @ 1310 nm | | | | | | | |
| (dB/turn) | | | | | | | |
| LP01 Bending loss @ | 4.58E−03 | 0.10 | 5.71E−04 | 1.52E−03 | 2.60E−03 | 2.78E−03 | 4.50E−05 |
| 5 mm @ 1310 nm | | | | | | | |
| (dB/turn) | | | | | | | |
| LP11 Bending loss @ | 0.40 | 11.92 | 0.09 | 0.45 | 0.31 | 2.07E−01 | 4.50E−02 |
| 5 mm @ 1310 nm | | | | | | | |
| (dB/turn) | | | | | | | |
| LP01 Bending loss @ | 1.093 | 24.2 | 0.71 | 1.99 | 0.50 | 0.40 | 0.18 |
| 3 mm @ 1550 nm | | | | | | | |
| (dB/turn) | | | | | | | |
| LP11 Bending loss @ | 31 | 56.2 | 22.30 | 28.54 | 30.377 | 28.87 | 31.249 |
| 3 mm @ 1550 nm | | | | | | | |
| (dB/turn) | | | | | | | |
| LP01 Bending loss @ | 0.06 | 0.84 | 0.01 | 0.02 | 0.03 | 0.03 | 1.33E−03 |
| 5 mm @1550 nm | | | | | | | |
| (dB/turn) | | | | | | | |
| LP11 Bending loss @ | 6.4157 | 41.17 | 1.48 | 4.776 | 5.098 | 2.355 | 2.3 |
| 5 mm @ 1550 nm | | | | | | | |
| (dB/turn) | | | | | | | |

The results in Table 2 above reveal various things. Examples 1-5 reveal that the relative refractive index profile can be engineered to establish the cutoff wavelength above the operating wavelength such as 1310 nm and the loop at 3 mm suppresses propagation of the first higher order mode (LP11) while not materially suppressing propagation of the fundamental mode (LP01). The optical fiber of Comparative Example 2, with the cutoff wavelength of 1156 nm below the operating wavelength of 1310 nm also suppresses the first higher order mode (LP11). However, the optical fiber of Comparative Example 2, when including the loop at a loop diameter of 3 mm, additionally materially suppresses the fundamental mode (LP01).

Similar results are shown for the operating wavelength of 1550 nm. The optical fibers of Examples 1-4 all have cutoff wavelengths above that operating wavelength of 1550 nm. The cutoff wavelength of Example 5 is only slightly below the operating wavelength of 1550 nm. Nevertheless, when the optical fibers of Examples 1-5 include a loop with a loop diameter of 3 mm, the optical fibers effectively suppress the first higher order mode (LP11) nearly as effectively as the optical fiber of Comparative Example 2 (with the cutoff wavelength well below the operating wavelength of 1550 nm) but without also materially suppressing the fundamental mode (LP01) as the optical fiber of Comparative Example 2 does. Similarly, the optical fiber of Comparative Example 1 suppresses the fundamental mode (LP01) at the operating wavelength of 1550 nm, when including a loop, about twice as much as the optical fibers of Examples 1-5 (except for Example 2 at 3 mm loop diameter).

In addition, Examples 1-5 reveal that the relative refractive index profile can be engineered to suppress, when including the one or more loops, the first higher order mode (LP11) but not the fundamental mode (LP01) at both the operating wavelengths of 1310 nm and 1550 nm. When the optical fibers include the loop with a loop diameter of 3 mm, and at the operating wavelength of 1310 nm, Examples 1 and 3-5 suppress the fundamental mode (LP01) less than the optical fiber of Comparative Example 1. Similarly, when the optical fibers include the loop with a loop diameter of 3 mm, and at the operating wavelength of 1550 nm, all of Examples 1-5 suppress the fundamental mode (LP01) less than the optical fiber of Comparative Example 1.

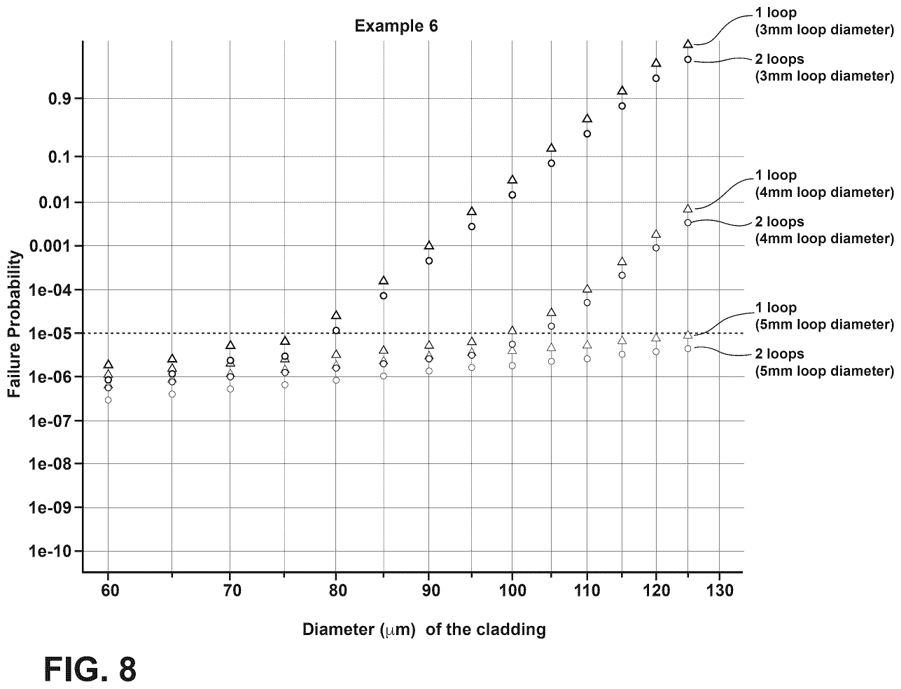

Example 6—For Example 6, the probability of failure of an optical fiber with a cladding region of pure silica after five years as a function of the diameter of the cladding region (2× the terminal radius (r_{T})) and as a function of the loop diameter of the one or more loops of the optical fiber, assuming a fatigue resistance n value of 20, was calculated. The fatigue resistance n value is understood in the art. For a general discussion of the measurement of fatigue resistance n value, see Glaesemann, Jakus, and Ritter, “Strength Variability of Indented Soda-Lime Glass”, Journal of the American Ceramic Society, Vol. 70, No. 6, June 1987, pp. 441-444. The results were plotted on the graph reproduced as FIG. 8. In the graph of FIG. 8, and the similar graphs that follow, the y-axis is on a scale of 0 to 1, with 0 meaning 0% failure probability, 1 meaning 100% failure probability, 0.01 meaning 1% failure probability and so on.

As the graph shows, if the failure probability of 1e-05 (1×10⁻⁵) is predetermined to be the maximum failure probability (horizontal dotted line) after more than 5 years, than an optical fiber that has cladding of pure silica (e.g., no second outer cladding region with TiO₂) and a terminal diameter of 125 μm (terminal outer radius (r_{T}) of 62.5 μm) can only be subjected to one or two loops with a 5 mm loop diameter. For the optical fiber to sustain one or two loops having a loop diameter of 3 mm, the terminal diameter of the cladding ought to be less than 80 μm such as about 75 μm or less (a terminal radius (r_{T}) of 37.5 μm or less).

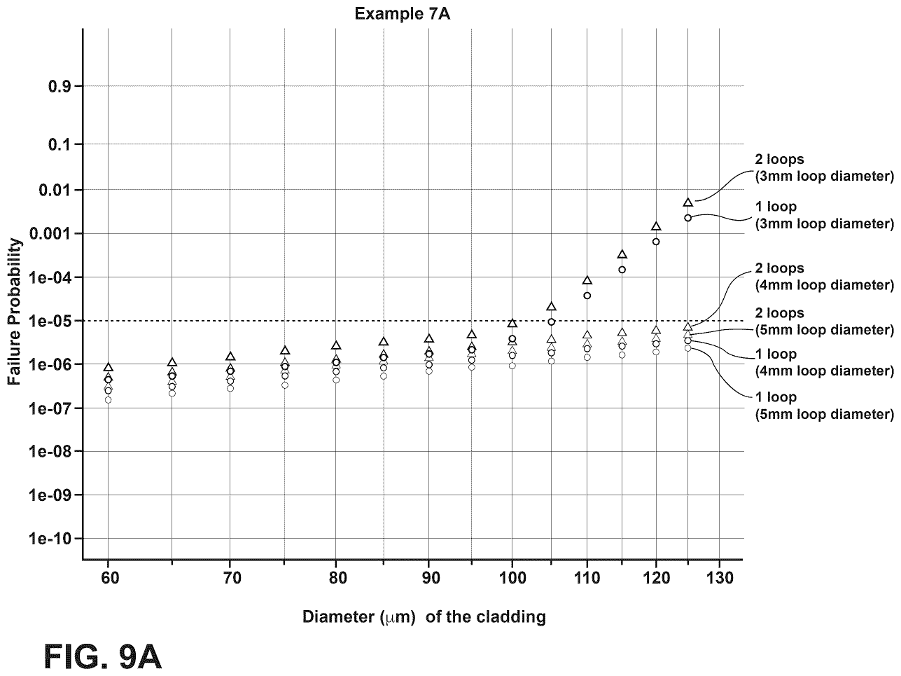

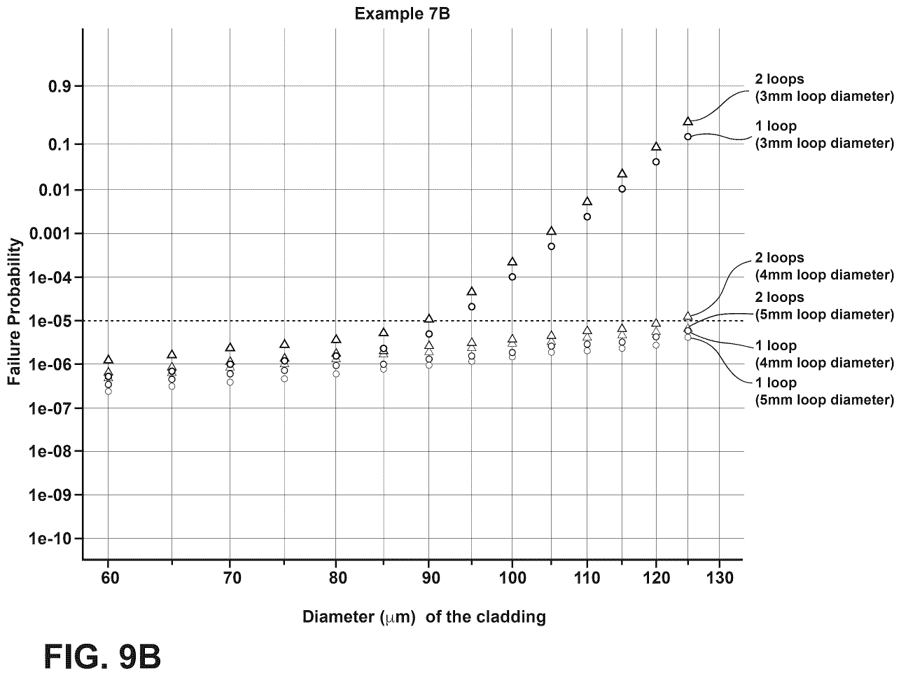

Examples 7A and 7B—For Examples 7A and 7B, the probability of failure of an optical fiber with a cladding region of silica doped with sufficient TiO₂ to increase the fatigue resistance n value to 26 was calculated in the same manner as Example 6. Although adding TiO₂ to the cladding increases the fatigue resistance, adding TiO₂ to the cladding additionally lowers the strength compared to the cladding of pure silica. Example 7A assumes the strength is reduced by 10%. Example 7B assumes the strength is reduced by 20%. The results were plotted on the graphs reproduced as FIGS. 9A and 9B.

As the graphs show, the optical fiber with the cladding including TiO₂ can have a terminal diameter of 125 μm or less and have a failure probability below the predetermined limit regardless of the strength reduction resulting from the inclusion of TiO₂, when the loop diameter is 5 mm. However, the graph of FIG. 9A shows that, when the inclusion of TiO₂ reduces strength by 10% and the loop diameter is reduced to 3 mm, the terminal diameter should be reduced to 100 μm or less to maintain the failure probability below the predetermined limit. Similarly, the graph of FIG. 9B shows that, when the inclusion of TiO₂ reduces strength by 20% and the loop diameter is reduced to 3 mm, the terminal diameter should be reduced to 90 μm or less for 1 loop or to 85 μm or less to maintain the failure probability below the predetermined limit.

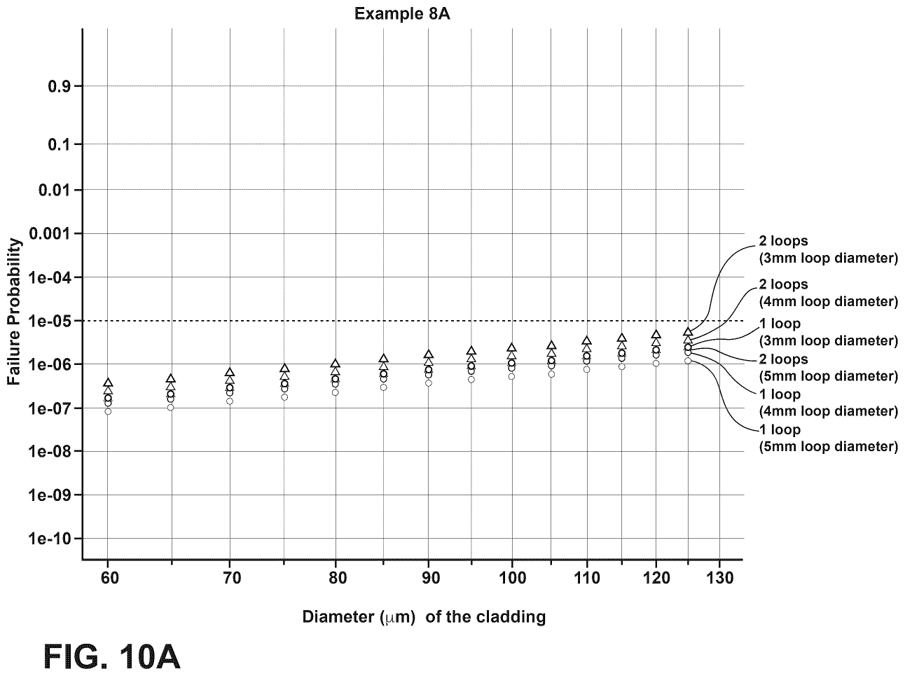

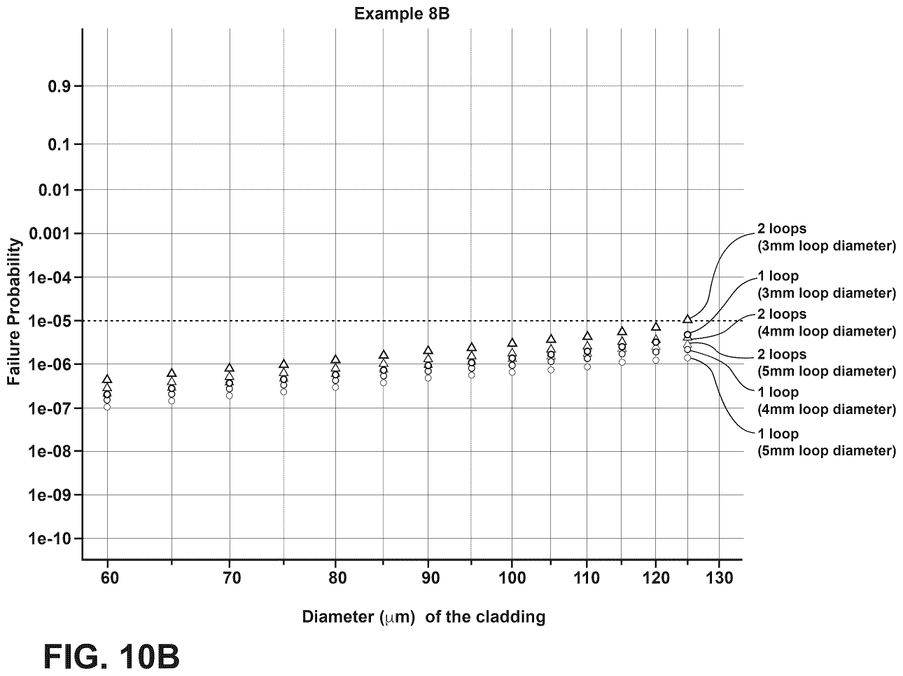

Examples 8A and 8B—For Examples 8A and 8B, the probability of failure of an optical fiber with a cladding region of silica doped with sufficient TiO₂ to increase the fatigue resistance n value to 33 was calculated in the same manner as Example 6. Example 8A assumes the strength is reduced by 10%. Example 8B assumes the strength is reduced by 10%. The results were plotted on the graphs reproduced as FIGS. 10A and 10B.

As the graphs show, the optical fiber with the cladding including TiO₂ can have a terminal diameter of 125 μm or less and have a failure probability below the predetermined limit regardless of the strength reduction resulting from the inclusion of TiO₂, when the loop diameter is 5 mm. Similarly, the graph of FIG. 10A shows that, even when the inclusion of TiO₂ reduces strength by 10% and the loop diameter is reduced to 3 mm, the terminal diameter can still be 125 μm or less to maintain the failure probability below the predetermined limit. The graph of FIG. 9B shows that, when the inclusion of TiO₂ reduces strength by 20% and the loop diameter is reduced to 3 mm, the terminal diameter can still be 125 μm or less for 1 loop but should be reduced to 120 μm or less for 2 loops to maintain the failure probability below the predetermined limit.

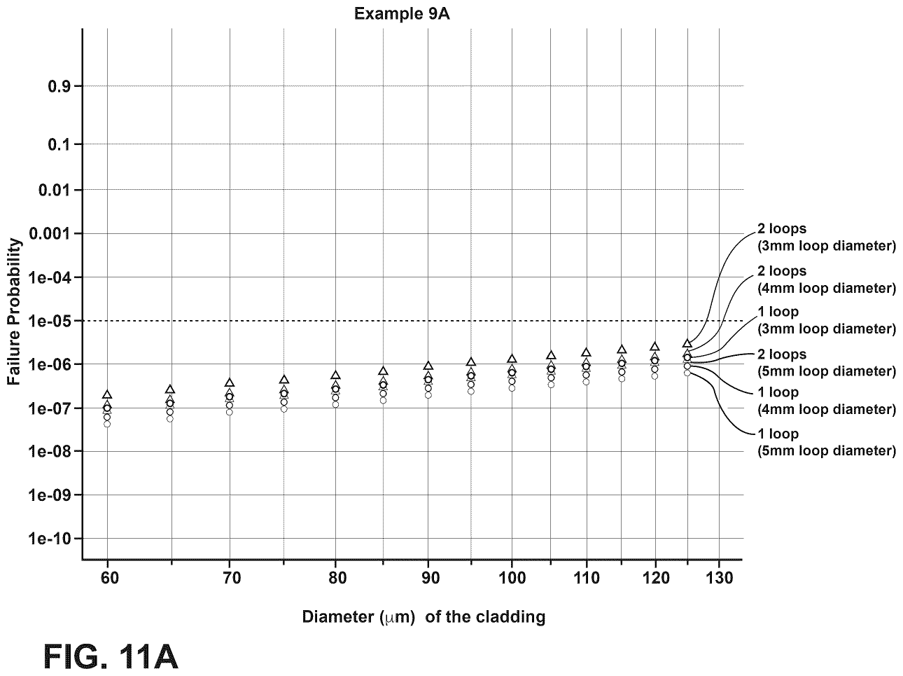

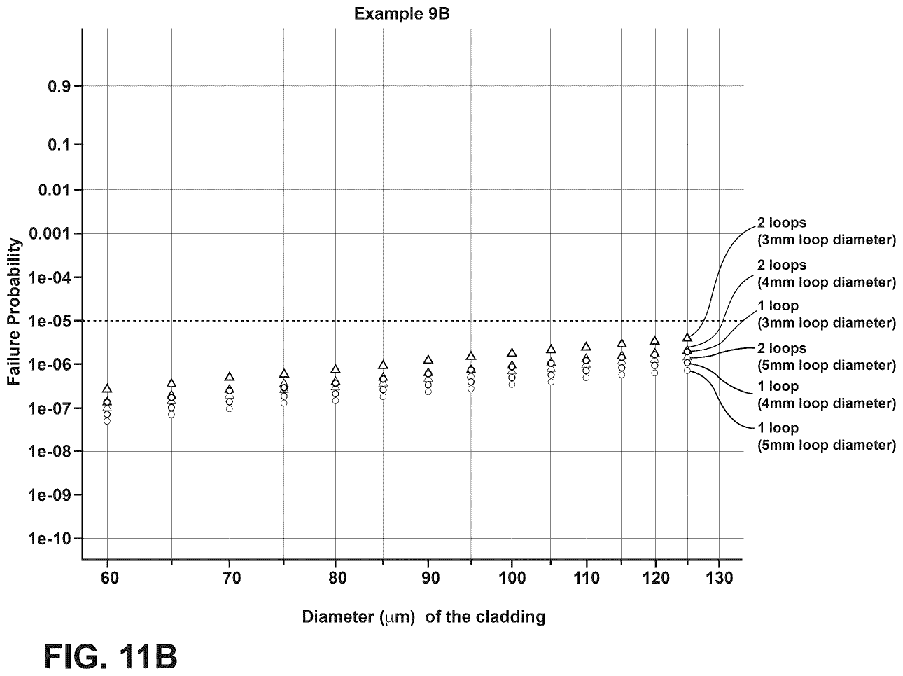

Examples 9A and 9B—For Examples 9A and 9B, the probability of failure of an optical fiber with a cladding region of silica doped with sufficient TiO₂ to increase the fatigue resistance n value to 45 was calculated in the same manner as Example 6. Example 9A assumes the strength is reduced by 10%. Example 9B assumes the strength is reduced by 10%. The results were plotted on the graphs reproduced as FIGS. 11A and 11B.

As the graphs show, the optical fiber with the cladding including TiO₂ can have a terminal diameter of 125 μm or less and have a failure probability below the predetermined limit regardless of the strength reduction resulting from the inclusion of TiO₂, regardless of whether the loop diameter is 5 mm or 3 mm and whether the number of loops is 1 or 2.

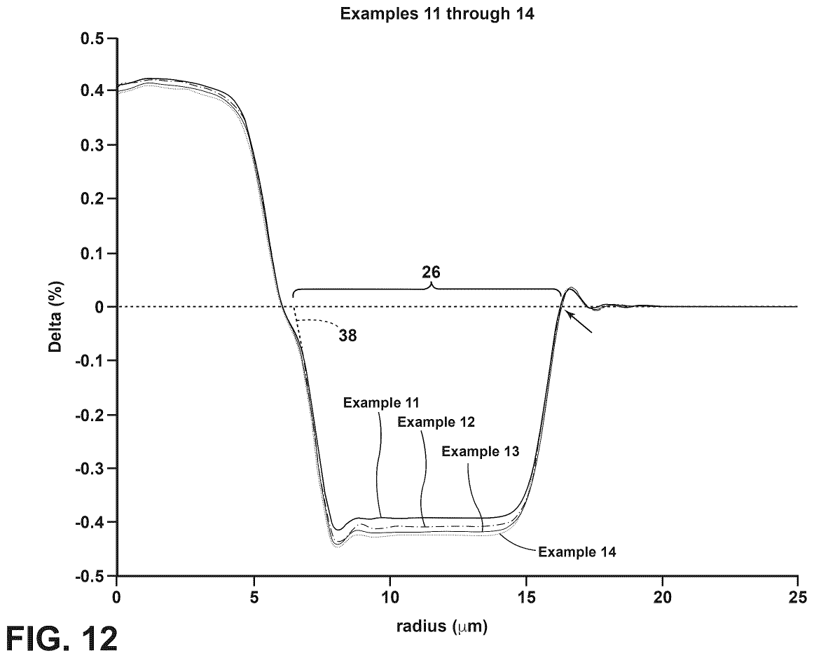

Examples 11 through 14—For Examples 11-14, optical fibers of the present disclosure were fabricated. All the optical fibers of Examples 11-14 were drawn from a common preform—the only difference between them being the tension applied to the optical fiber during the draw. More specifically, the optical fiber of Example 11 was drawn with a tension of 110 grams, the optical fiber of Example 12 was drawn with a tension of 90 grams, the optical fiber of Example 13 was drawn with a tension of 60 grams, and the optical fiber of Example 14 was drawn with a tension of 40 grams. The relative refractive index profiles as a function of radius from the axis of the optical fiber are reproduced at FIG. 12. As the graph illustrates, as the tension of the draw increases, the maximum relative refractive index of the core region increases, as does the relative refractive index of the depressed index cladding region (e.g., becomes less negative, moves up on the y-axis). It is noted that, in FIG. 12, that the relative refracted index valley at a radius of about 8 μm within the trench and the relative refractive index hill at a radius of about 16 μm crossing the 0% baseline are measurement artifacts and do not actually exist. It is believed that the measurement device does not properly handle abrupt changes in slope of relative refractive index.

Various properties of the optical fibers were calculated via computer model and separately physically measured. The computer model calculations are tabulated in Table 3 below.

TABLE 3

| | MFD @ | MFD @ | Cutoff | Lambda0 |
|---|---|---|---|---|
| Example | 1310 (μm) | 1550 (μm) | (nm) | (nm) |
| Example 11 | 9.1 | 9.7 | 1549 | 1264.97 |
| Example 12 | 9.1 | 9.7 | 1535 | 1264.80 |
| Example 13 | 9.1 | 9.7 | 1514 | 1264.42 |
| Example 14 | 9.1 | 9.7 | 1493.5 | 1264.41 |

“MFD” again refers to mode field diameter. “Cutoff” again refers to the cutoff wavelength. “Lambda0” is the wavelength at which the optical fiber exhibits its lowest level of attenuation (signal loss) for the fundamental mode (LP01).

The results of the physical measurements are tabulated in Table 4 below.

TABLE 4

| | | MFD @ | MFD @ | Attenuation @ | Attenuation @ | |
|---|---|---|---|---|---|---|
| | Tension | 1310 | 1550 | 1310 nm | 1550 nm | Cutoff |
| Example | (g) | (μm) | (μm) | (dB/km) | (dB/km) | (nm) |
| Example 11 | 110 | 9.1 | 9.3 | 0.347 | 0.249 | n/a |
| Example 12 | 90 | 8.93 | 9.54 | 0.347 | 0.216 | 1564 |
| Example 13 | 60 | 8.79 | 9.73 | 0.344 | 0.209 | 1542 |
| Example 14 | 40 | 8.76 | 9.68 | 0.357 | 0.217 | 1528 |

The optical fibers of Examples 11-14 do not include the second outer cladding region that includes TiO₂ to increase the mechanical reliability of the optical fiber. However, the addition of the second outer cladding region that includes TiO₂ is not expected to alter the optical performance.

In addition, computer modeling was used to determine the attenuation of the fundamental mode (LP01) and the first higher order mode (LP11) that a loop of the optical fiber causes as a function of loop diameter and wavelength of electromagnetic radiation. The results are tabulated in Table 5 below.

TABLE 5

| | Example 12 | Example 13 |
|---|---|---|
| LP01 3 mm Diameter | 0.056 | 0.0526 |
| Bending loss @ 1310 nm | | |
| (dB/turn) | | |
| LP11 3 mm Diameter | 2.57 | 2.47 |
| Bending loss @ 1310 nm | | |
| (dB/turn) | | |
| LP01 5 mm Diameter | 3.00E−03 | 0.0029 |
| Bending loss @ 1310 nm | | |
| (dB/turn) | | |
| LP11 5 mm Diameter | 0.1671 | 0.1643 |
| Bending loss @ 1310 nm | | |
| (dB/turn) | | |
| LP01 3 mm Diameter | 0.4134 | 0.4062 |
| Bending loss @ 1550 nm | | |
| (dB/turn) | | |
| LP11 3 mm Diameter | 16.3928 | |
| Bending loss @ 1550 nm | | |
| (dB/turn) | | |
| LP01 5 mm Diameter | 0.0383 | 0.0376 |
| Bending loss @ 1550 nm | | |
| (dB/turn) | | |
| LP11 5 mm Diameter | 1.6703 | |
| Bending loss @ 1550 nm | | |
| (dB/turn) | | |

The results reveal that the optical fibers of Examples 12 and 13, when including one or more loops, attenuate the first higher order mode (LP11) to a much greater extent than the fundamental mode (LP01) at loop diameters of 3 mm and 5 mm and an operating wavelength of 1310 nm. In addition, the results reveal that the optical fibers of Examples 12 and 13, when including a loop, attenuate the fundamental mode (LP01) to an acceptably low degree at loop diameters of 3 mm and 5 mm and an operating wavelength of 1550 nm.

Finally, the optical fiber of Example 13 was spliced with a pigtail jumper (a short length of optical fiber with a connector at one end). The core region of the optical fiber was aligned with the core of the pigtail jumper. The optical fiber was then looped with sequentially increasing loop diameters of 3.15 mm, 4 mm, and 5 mm to determine the resulting attenuation of the fundamental mode (LP01) at an operating wavelength of 1310 nm for each loop diameter. The attenuation was 0.036 dB/loop, 0.01 dB/loop and 0.006 dB/loop respectively.

What is claimed is:

1. An optical fiber comprising:
a first outer cladding region comprising a no-slope portion where the first outer cladding has a refractive index that is substantially constant as a function of a radius from an axis of the optical fiber, wherein the no-slope portion establishes a 0% baseline (Δ₀) for relative refractive indices;
a core region surrounded by the first outer cladding region, the core region comprising (i) an outer radius (r₁) within a range of from 4.0 μm to 6.5 μm from the axis of the optical fiber and (ii) a maximum relative refractive index (Δ₁ₘₐₓ) within a range of from 0.3% to 0.6%, the core region exhibiting an α value that is greater than or equal to 5; and
a depressed index cladding region surrounding the core region and surrounded by the first outer cladding region, the depressed index cladding region comprising (i) an outer radius (r₃) from the axis of the optical fiber within a range of from 14 μm to 28 μm, (ii) a relative refractive index (Δ₃) within a range of from −0.45% to −0.30%, and (iii) a trench volume (V_{T}) that is within a range of from 65%-μm² to 140%-μm²;
wherein, the optical fiber exhibits a LP01 bending loss for electromagnetic radiation having a wavelength within a range of from 1260 nm to 1360 nm, (i) when bent 1 turn around a 3 mm diameter mandrel, that is within a range of from 0.005 dB to 0.35 dB and, (ii) when bent 1 turn around a 5 mm diameter mandrel, that is within a range of from 0.000010 dB to 0.0050 dB,
wherein, the optical fiber exhibits a LP11 bending loss for electromagnetic radiation having a wavelength within a range of from 1260 nm to 1360 nm, (i) when bent 1 turn around a 3 mm diameter mandrel, that is within a range of from 2.00 dB to 17.0 dB and, (ii) when bent 1 turn around a 5 mm diameter mandrel, that is within a range of from 0.010 dB to 1.00 dB,
wherein, the optical fiber exhibits a LP01 bending loss for electromagnetic radiation having a wavelength within a range of from 1530 nm to 1565 nm, (i) when bent 1 turn around a 3 mm diameter mandrel, that is within a range of from 0.010 dB to 2.50 dB, and (ii) when bent 1 turn around a 5 mm diameter mandrel, that is within a range of from 0.005 dB to 0.05 dB, and
wherein, the optical fiber exhibits a LP11 bending loss for electromagnetic radiation having a wavelength within a range of from 1530 nm to 1565 nm, (i) when bent 1 turn around a 3 mm diameter mandrel that is within a range of from 10.00 dB to 35.00 dB, and (ii) when bent 1 turn around a 5 mm diameter mandrel, that is within a range of from 1.00 dB to 6.00 dB.

2. The optical fiber of claim 1 further comprising:
an inner cladding region surrounding the core region and disposed between the core region and the depressed index cladding region, the inner cladding region comprising (i) a relative refractive index (Δ₂) within a range of from −0.05% to 0.05% and (ii) an outer radius (r₂) from the axis of the optical fiber that is within a range of from 5.0 μm to 17 μm.

3. The optical fiber of claim 1, wherein
the first outer cladding region further comprises an outer radius (r₄) from the axis of the optical fiber that defines a terminal outer surface of all glass-based cladding regions of the optical fiber, the outer radius (r₄) being less than or equal to 40 μm.

4. The optical fiber of claim 1 further comprising:
a second outer cladding region surrounding the first outer cladding region, the second outer cladding region comprising (i) silica glass doped with 4 wt % to 20 wt % TiO₂, (ii) an outer radius (r₅) within a range of from 33 μm to 70 μm, and (iii) a radial thickness (T_{M}) within a range of from 3 μm to 30 μm.

5. The optical fiber of claim 4, wherein
the outer radius (r₅) of the second outer cladding from the axis of the optical fiber is within a range of from 33 μm to 55 μm.

6. The optical fiber of claim 1, wherein
the α value that the core region exhibits is within a range of from 7 to 21.

7. The optical fiber of claim 1, wherein
the optical fiber exhibits a mode field diameter for electromagnetic radiation having a wavelength of 1310 nm (MFD₁₃₁₀) within a range of from 8.0 μm to 9.5 μm.

8. The optical fiber of claim 1, wherein
the optical fiber exhibits a cutoff wavelength, for the fundamental mode (LP01), within a range of from 1450 nm to 1675 nm.

9. A micro-optic device comprising:
a photonics device; and
an optical fiber comprising:
a first end coupled to the photonics device;
a second end;
one or more loops between the first end and the second end, the one or more loops comprising a loop diameter within a range of from 2.5 mm and 5.5 mm;
a first outer cladding region comprising a no-slope portion where a refractive index of the first outer cladding region is substantially constant as a function of radius from an axis of the optical fiber, wherein the no-slope portion defines a 0% baseline (Δ₀) for relative refractive indices;
a core region surrounded by the first outer cladding region, the core region comprising (i) an outer radius (r₁) within a range of from 4.0 μm to 6.5 μm from the axis of the optical fiber and (ii) a maximum relative refractive index (Δ₁ₘₐₓ) within a range of from 0.3% to 0.6%, the core region exhibiting an α value that is greater than or equal to 5; and
a depressed index cladding region surrounding the core region and surrounded by the first outer cladding region, the depressed index cladding region comprising (i) an outer radius (r₃) from the axis of the optical fiber within a range of from 14 μm to 28 μm, (ii) a relative refractive index (Δ₃) within a range of from −0.45% to −0.30%, and (iii) a trench volume (V_{T}) that is within a range of from 65%-μm² to 140%-μm².

10. The micro-optic device of claim 9, wherein
the optical fiber further comprises:
an inner cladding region surrounding the core region and disposed between the core region and the depressed index cladding region, the inner cladding region comprising (i) a relative refractive index (Δ₂) within a range of from −0.05% to 0.05% and (ii) an outer radius (r₂) from the axis of the optical fiber that is within a range of from 5.0 μm to 17 μm.

11. The micro-optic device of claim 9, wherein
the first outer cladding region of the optical fiber further comprises an outer radius (r₄) from the axis of the optical fiber that defines a terminal outer surface of all glass-based cladding regions of the optical fiber, the outer radius (r₄) having a value of less than or equal to 40 μm.

12. The micro-optic device of claim 9, wherein
the optical fiber further comprises:
a second outer cladding region surrounding the first outer cladding region, the second outer cladding region comprising (i) silica base glass doped with 4 wt % to 20 wt % TiO₂, (ii) an outer radius (r₅) from the axis of the optical fiber that is within a range of from 30 μm to 70 μm, and (iii) a radial thickness (T_{M}) within a range of from 3 μm to 30 μm.

13. The micro-optic device of claim 9, wherein
the α value that the core region of the optical fiber exhibits is within a range of from 7 to 21.

14. The micro-optic device of claim 9, wherein
the optical fiber exhibits a cutoff wavelength, for the fundamental mode (LP01) within a range of from 1450 nm to 1675 nm.

15. The micro-optic device of claim 9, wherein
the loop diameter of the one or more loops is within a range of from 2.9 mm to 3.1 mm,
the fundamental mode (LP01) of electromagnetic radiation having a wavelength within a range of from 1260 nm to 1360 nm enters the first end of the optical fiber and exits the second end of the optical fiber having been attenuated by a value within a range of from 0.005 dB/loop to 0.35 dB/loop, and
the first higher order mode (LP11) of electromagnetic radiation having a wavelength within a range of from 1260 nm to 1360 nm enters the first end of the optical fiber and exits the second end of the optical fiber having been attenuated by a value within a range of from 2.00 dB/loop to 17.0 dB/loop.

16. The micro-optic device of claim 9, wherein
the loop diameter is within a range of from 4.9 mm to 5.1 mm,
the fundamental mode (LP01) of electromagnetic radiation having a wavelength within a range of from 1530 nm to 1565 nm enters the first end of the optical fiber and exits the second end of the optical fiber having been attenuated by a value within a range of from 0.005 dB/loop to 0.050 dB/loop, and
the first higher order mode (LP11) of electromagnetic radiation having wavelength within a range of from 1530 nm to 1565 nm enters the first end of the optical fiber and exits the second end of the optical fiber having been attenuated by a value within a range of from 1.00 dB/loop to 6.00 dB/loop.

17. A method of suppressing a first higher order mode (LP11) of optical fiber propagation comprising:
transmitting electromagnetic radiation comprising a fundamental mode (LP01) and a first higher order mode (LP11) of optical fiber propagation at a first power ratio (P_{LP01-1}/P_{LP11-1}) into a first end of an optical fiber, the optical fiber further comprising a second end and one or more loops between the first end and the second end, the one or more loops comprising a loop diameter within a range of from 2.5 mm and 5.5 mm; and
transmitting the electromagnetic radiation out of the second end of the optical fiber, the electromagnetic radiation transmitted out of the second end of the optical fiber at a second power ratio (P_{LP01-2}/P_{LP11-2}),
wherein, the one or more loops is sufficient to increase the second power ratio (P_{LP01-2}/P_{LP11-2}) relative to the first power ratio (P_{LP01-1}/P_{LP11-1}) by a factor of at least 1.1.

18. The method of claim 17, wherein
the optical fiber exhibits a mode field diameter for electromagnetic radiation having a wavelength of 1310 nm (MFD₁₃₁₀) within a range of from 8.0 μm to 9.5 μm.

19. The method of claim 17, wherein
the one or more loops is sufficient to increase the second power ratio (P_{LP01-2}/P_{LP11-2}) relative to the first power ratio (P_{LP01-1}/P_{LP11-1}) by a factor of at least 10.

20. The method of claim 17, wherein
the optical fiber exhibits a cutoff wavelength, for the fundamental mode (LP01) within a range of from 1450 nm to 1675 nm.
